(19) United States
(12) Patent Application Publication
(10) Pub. No.: US 2026/0095200 A1
(43) Pub. Date: Apr. 2, 2026

(54) RADIO-FREQUENCY CIRCUIT AND COMMUNICATION DEVICE

(71) Applicant: Murata Manufacturing Co., Ltd., Nagaokakyo-shi (JP)

(72) Inventors: Atsushi HORITA, Nagaokakyo-shi (JP); Hirotsugu MORI, Nagaokakyo-shi (JP)

(73) Assignee: Murata Manufacturing Co., Ltd., Nagaokakyo-shi (JP)

(21) Appl. No.: 19/412,880

(22) Filed: Dec. 9, 2025

Related U.S. Application Data
(63) Continuation of application No. PCT/JP2024/008975, filed on Mar. 8, 2024.

(30) Foreign Application Priority Data
Jun. 16, 2023 (JP) 2023-099393

(51) Int. Cl. H04B 1/10

(52) U.S. Cl. CPC H04B 1/10

(57) ABSTRACT

A radio-frequency circuit includes first filter having a pass band including the transmit band of communication band A and a second filter having a pass band including the receive band of communication band B. The communication bands A and B are usable for simultaneous communication. The transmit band of the communication band A includes a sub-band X that overlaps the receive band of the communication band B and a sub-band Y that does not overlap the receive band of the communication band B. The receive band of the communication band B includes the sub-band X and a sub-band Z that does not overlap the transmit band of the communication band A. The pass band of the first filter is switchable between a first pass band including the sub-band X and the sub-band Y and a second pass band, narrower than the first pass band, including the sub-band Y.

### CROSS-REFERENCE TO RELATED APPLICATIONS

This is a continuation application of PCT International Application No. PCT/JP2024/008975 filed on Mar. 8, 2024, designating the United States of America, which is based on and claims priority of Japanese Patent Application No. 2023-099393 filed on Jun. 16, 2023. The entire disclosures of the above-identified applications, including the specifications, drawings, and claims are incorporated herein by reference in their entirety.

### BACKGROUND

### 1. Field

The present disclosure relates to a radio-frequency circuit and a communication device.

### 2. Description of the Related Art

It is desired that a multiband-support front-end circuit transmit and receive multiple radio-frequency signals with a small loss and a high isolation.

U.S. Patent Application Publication No. 2016/0127015 discloses a radio-frequency module (radio-frequency circuit) configured in which multiple filters having different pass bands are connected to an antenna via a multiplexer (switch).

### SUMMARY

3GPP (registered trademark) (3rd Generation Partnership Project) is studying simultaneous transfer of signals of two communication bands whose frequency bands partially overlap each other.

The present disclosure is directed to providing a small-sized radio-frequency circuit and communication device that can execute simultaneous transfer of signals of two communication bands whose frequency bands partially overlap each other while reducing the degradation of isolation and reception sensitivity.

A radio-frequency circuit according to an aspect of the disclosure includes first and second filters. The first filter has a pass band including a first frequency band, which is one of a transmit band and a receive band of a first communication band. The second filter has a pass band including a second frequency band, which is the other one of the transmit band and the receive band of a second communication band. The first communication band and the second communication band are a combination of bands that are usable for simultaneous communication. The first frequency band includes a first sub-band that overlaps the second frequency band and a second sub-band that does not overlap the second frequency band. The second frequency band includes the first sub-band and a third sub-band that does not overlap the first communication band. The pass band of the first filter is switchable between a first pass band including the first sub-band and the second sub-band and a second pass band including the second sub-band. The second pass band is narrower than the first pass band.

According to an embodiment of the disclosure, it is possible to provide a small-sized radio-frequency circuit and communication device that can execute simultaneous transfer of signals of two communication bands whose frequency bands partially overlap each other while reducing the degradation of isolation and reception sensitivity.

### BRIEF DESCRIPTION OF THE DRAWINGS

FIG. 1 is a circuit diagram of a radio-frequency circuit and a communication device according to an embodiment;

FIG. 2 is a diagram illustrating an example of the relationship between the frequency ranges of communication bands to be applied to the radio-frequency circuit of the embodiment and an example of the bandpass characteristics of filters of the radio-frequency circuit;

FIG. 3A is a circuit diagram illustrating the connection state of a first switch when a signal of a first communication band is singly transferred in the radio-frequency circuit of the embodiment;

FIG. 3B is a circuit diagram illustrating the connection state of the first switch when a signal of the first communication band and a signal of a second communication band are simultaneously transferred in the radio-frequency circuit of the embodiment;

FIG. 4A is a diagram illustrating an example of the relationship between the frequency ranges of communication bands to be applied to a radio-frequency circuit of a first modified example and an example of the bandpass characteristics of filters of the radio-frequency circuit of the first modified example;

FIG. 4B is a diagram illustrating an example of the relationship between the frequency ranges of communication bands to be applied to a radio-frequency circuit of a second modified example and an example of the bandpass characteristics of filters of the radio-frequency circuit of the second modified example;

FIG. 5A illustrates a first example of the circuit configuration of a first filter in the embodiment;

FIG. 5B illustrates a second example of the circuit configuration of the first filter in the embodiment;

FIG. 5C illustrates a third example of the circuit configuration of the first filter in the embodiment;

FIG. 6 is a diagram illustrating an example of the relationships between the frequency ranges of communication bands to be applied to a radio-frequency circuit of a third modified example and an example of the bandpass characteristics of filters of the radio-frequency circuit of the third modified example;

FIG. 7A is a circuit diagram illustrating a first connection state of a radio-frequency circuit according to a fourth modified example;

FIG. 7B is a diagram illustrating an example of the relationships between the frequency ranges of communication bands to be applied to the radio-frequency circuit of the fourth modified example and an example of the bandpass characteristics of filters of the radio-frequency circuit of the fourth modified example in the first connection state;

FIG. 8A is a circuit diagram illustrating a second connection state of the radio-frequency circuit according to the fourth modified example;

FIG. 8B is a diagram illustrating an example of the relationships between the frequency ranges of communication bands to be applied to the radio-frequency circuit of the fourth modified example and an example of the bandpass characteristics of the filters of the radio-frequency circuit of the fourth modified example in the second connection state;

FIG. 9A is a circuit diagram of a radio-frequency circuit and a diversity circuit according to a fifth modified example; and

FIG. 9B is a circuit diagram of a radio-frequency circuit and a primary circuit according to a sixth modified example.

### DESCRIPTION OF EMBODIMENTS

Embodiments of the disclosure will be described below in detail with reference to the accompanying drawings. The embodiments described below illustrate general or specific examples. Numerical values, shapes, materials, components, and positions and connection states of the components explained in the following embodiments are only examples and are not intended to limit the disclosure.

The drawings are only schematically shown and are not necessarily precisely illustrated. For the sake of representation, the drawings may be illustrated in an exaggerated manner or with omissions or the ratios of components in the drawings may have been adjusted. The shapes, positional relationships, and ratios of components in the drawings may be different from those of the actual components. In the drawings, components having substantially the same configuration are designated by like reference numeral, and it may be possible that an explanation of such components be not repeated or be merely simplified.

In the disclosure, “A is connected to B” includes, not only the meaning that A is directly connected to B using a connection terminal and/or a wiring conductor, but also the meaning that A is electrically connected to B via another circuit element. “Being connected between A and B” means that “being connected to both A and B on a path which connects A and B”.

In the disclosure, “transmit path” means a transmission line constituted by wiring for transferring a radio-frequency transmission signal, an electrode directly connected to the wiring, and a terminal directly connected to the wiring or the electrode, for example. In the disclosure, “receive path” means a transmission line constituted by wiring for transferring a radio-frequency reception signal, an electrode directly connected to the wiring, and a terminal directly connected to the wiring or the electrode, for example.

In the disclosure, the pass band of a filter is defined as the frequency band between two frequencies, which are greater than the smallest value of the insertion loss within the pass band by 3 dB.

### Embodiment

### 1 Circuit Configurations of Radio-Frequency Circuit 1 and Communication Device 4

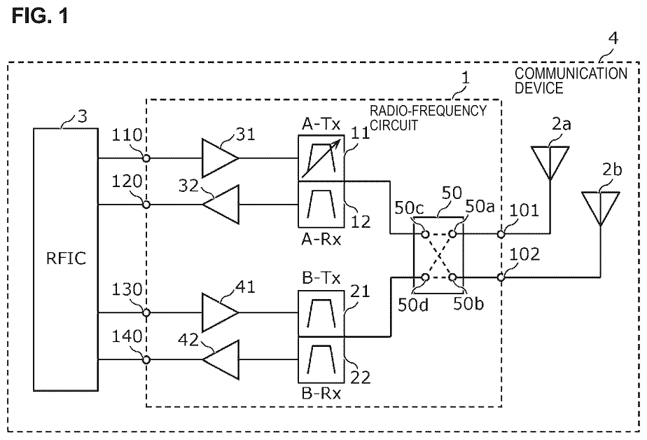

The circuit configurations of a radio-frequency circuit 1 and a communication device 4 according to an embodiment will be described below with reference to FIG. 1. FIG. 1 is a circuit diagram of the radio-frequency circuit 1 and the communication device 4 according to the embodiment.

### 1.1 Circuit Configuration of Communication Device 4

The circuit configuration of the communication device 4 will first be explained. As illustrated in FIG. 1, the communication device 4 according to the embodiment includes the radio-frequency circuit 1, antennas 2a and 2b, and a radio-frequency (RF) signal processing circuit 3. Hereinafter, the radio-frequency (RF) signal processing circuit 3 will be called the RFIC (radio-frequency integrated circuit) 3.

The radio-frequency circuit 1 transfers a radio-frequency signal between the antennas 2a and 2b and the RFIC 3. The detailed circuit configuration of the radio-frequency circuit 1 will be discussed later.

The antenna 2a is connected to an antenna terminal 101 of the radio-frequency circuit 1. The antenna 2a transmits a radio-frequency signal output from the radio-frequency circuit 1 and also receives a radio-frequency signal from an external source and outputs it to the radio-frequency circuit 1. The antenna 2b is connected to an antenna terminal 102 of the radio-frequency circuit 1. The antenna 2b transmits a radio-frequency signal output from the radio-frequency circuit 1 and also receives a radio-frequency signal from an external source and outputs it to the radio-frequency circuit 1.

The RFIC 3 is an example of a signal processing circuit that processes a radio-frequency signal. The RFIC 3 will be explained below more specifically. The RFIC 3 performs signal processing, such as down-conversion, on a radio-frequency reception signal received via a receive path of the radio-frequency circuit 1 and outputs the resulting reception signal to a baseband signal processing circuit (baseband integrated circuit (BBIC)), which is not shown. The RFIC 3 also performs signal processing, such as up-conversion, on a transmission signal received from the BBIC and outputs the resulting radio-frequency transmission signal to a transmit path of the radio-frequency circuit 1. The RFIC 3 includes a controller that controls components, such as a switch and amplifiers, of the radio-frequency circuit 1. All or some of the functions of the RFIC 3 as the controller may be installed outside the RFIC 3, such as in the BBIC or the radio-frequency circuit 1.

The antennas 2a and 2b are not essential components for the communication device 4 of the embodiment.

### 1.2 Circuit Configuration of Radio-Frequency Circuit 1

The circuit configuration of the radio-frequency circuit 1 will now be described below. As illustrated in FIG. 1, the radio-frequency circuit 1 includes filters 11, 12, 21, and 22, a switch 50, power amplifiers 31 and 41, low-noise amplifiers 32 and 42, the antenna terminals 101 and 102, radio-frequency input terminals 110 and 130, and radio-frequency output terminals 120 and 140.

The antenna terminal 101 is connected to the antenna 2a and a terminal 50a of the switch 50. The antenna terminal 102 is connected to the antenna 2b and a terminal 50b of the switch 50. The radio-frequency input terminal 110 is connected to the RFIC 3 and the power amplifier 31 and is used for receiving a radio-frequency transmission signal from the RFIC 3. The radio-frequency input terminal 130 is connected to the RFIC 3 and the power amplifier 41 and is used for receiving a radio-frequency transmission signal from the RFIC 3. The radio-frequency output terminal 120 is connected to the RFIC 3 and the low-noise amplifier 32 and is used for outputting a radio-frequency reception signal to the RFIC 3. The radio-frequency output terminal 140 is connected to the RFIC 3 and the low-noise amplifier 42 and is used for outputting a radio-frequency reception signal to the RFIC 3.

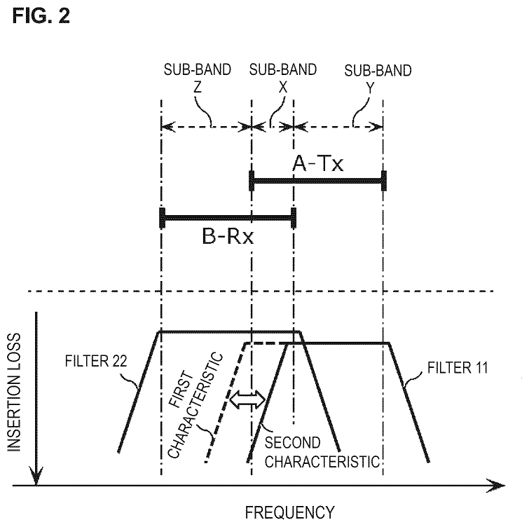

FIG. 2 is a diagram illustrating an example of the relationship between the frequency ranges of communication band A and communication band B to be applied to the radio-frequency circuit 1 of the embodiment and an example of the bandpass characteristics of the filters 11 and 22.

In the embodiment, the communication band A is an example of a first communication band, while the communication band B is an example of a second communication band. The communication band A and the communication band B are a combination of bands that can be used for simultaneous communication. As shown in FIG. 2, the frequency range of the transmit band (A-Tx) of the communication band A and that of the receive band (B-Rx) of the communication band B partially overlap each other.

In the embodiment, the transmit band of the communication band A is an example of a first frequency band, while the receive band of the communication band B is an example of a second frequency band. As shown in FIG. 2, the transmit band of the communication band A includes a sub-band X (first sub-band) that overlaps the receive band of the communication band B and a sub-band Y (second sub-band) that does not overlap the receive band of the communication band B. As also shown in FIG. 2, the receive band of the communication band B includes the sub-band X (first sub-band) that overlaps the transmit band of the communication band A and a sub-band Z (third sub-band) that does not overlap the transmit band of the communication band A.

In the disclosure, “one band and another band partially overlap each other” includes, not only the meaning that a partial frequency range of one band and a partial frequency range of another band overlap each other, but also the meaning that one point on the low frequency edge or the high frequency edge of one band and one point on the high frequency edge or the low frequency edge of another band match each other and the two bands do not match each other at the other frequency points.

That is, in the embodiment, the sub-band X may be constituted by one given frequency point.

In the disclosure, the above-described communication band A and communication band B, and communication band C and communication band D, which will be discussed later, each refer to a frequency band defined by a standardizing body (such as 3GPP (registered trademark) and IEEE (Institute of Electrical and Electronics Engineers)) for a communication system to be constructed using a radio access technology (RAT). As the communication system, a LTE (Long Term Evolution) system, a 5G (5th Generation)-NR (New Radio) system, and a WLAN (Wireless Local Area Network) system, for example, may be used. However, the communication system is not limited to these types of systems.

The filter 11 is an example of a first filter and has a pass band including the transmit band (first frequency band) of the communication band A. More specifically, the pass band of the filter 11 can be switched between a first pass band including the sub-band X and the sub-band Y and a second pass band including the sub-band Y. The second pass band is narrower than the first pass band. In other words, the filter 11 can be switched between a first characteristic representing the first pass band and a second characteristic representing the second pass band, based on a control signal from the RFIC 3, for example. One end of the filter 11 is connected to a terminal 50c (first terminal) of the switch 50 (first switch), and the other end of the filter 11 is connected to the output end of the power amplifier 31.

The filter 22 is an example of a second filter and has a pass band including the receive band (second frequency band) of the communication band B. One end of the filter 22 is connected to a terminal 50d (second terminal) of the switch 50 (first switch), and the other end of the filter 22 is connected to the input end of the low-noise amplifier 42.

The filter 12 has a pass band including the receive band of the communication band A. One end of the filter 12 is connected to the terminal 50c of the switch 50, and the other end of the filter 12 is connected to the input end of the low-noise amplifier 32.

The filter 21 has a pass band including the transmit band of the communication band B. One end of the filter 21 is connected to the terminal 50d of the switch 50, and the other end of the filter 21 is connected to the output end of the power amplifier 41.

The switch 50 is an example of a first switch. The switch 50 includes the terminal 50a (first antenna connection terminal), terminal 50b (second antenna connection terminal), terminal 50c (first terminal), and terminal 50d (second terminal). The switch 50 is a double pole double throw (DPDT) switch. The switch 50 switches between the connection of the terminal 50a to the terminal 50c and the disconnection of the terminal 50a from the terminal 50c and switches between the connection of the terminal 50a to the terminal 50d and the disconnection of the terminal 50a from the terminal 50d. The switch 50 also switches between the connection of the terminal 50b to the terminal 50c and the disconnection of the terminal 50b from the terminal 50c and switches between the connection of the terminal 50b to the terminal 50d and the disconnection of the terminal 50b from the terminal 50d. The terminal 50a is connected to the antenna terminal 101. The terminal 50b is connected to the antenna terminal 102. The terminal 50c is connected to the filters 11 and 12. The terminal 50d is connected to the filters 21 and 22. With the above-described connection configuration, the switch 50 switches between the connection of the antenna 2a to the filters 11 and 12 and the disconnection of the antenna 2a from the filters 11 and 12 and switches between the connection of the antenna 2a to the filters 21 and 22 and the disconnection of the antenna 2a from the filters 21 and 22. The switch 50 also switches between the connection of the antenna 2b to the filters 11 and 12 and the disconnection of the antenna 2b from the filters 11 and 12 and switches between the connection of the antenna 2b to the filters 21 and 22 and the disconnection of the antenna 2b from the filters 21 and 22.

The output end of the power amplifier 31 is connected to the filter 11, and the input end of the power amplifier 31 is connected to the radio-frequency input terminal 110. The power amplifier 31 amplifies a radio-frequency transmission signal (hereinafter simply called a transmission signal) of the communication band A input from the radio-frequency input terminal 110.

The output end of the power amplifier 41 is connected to the filter 21, and the input end of the power amplifier 41 is connected to the radio-frequency input terminal 130. The power amplifier 41 amplifies a transmission signal of the communication band B input from the radio-frequency input terminal 130.

The input end of the low-noise amplifier 32 is connected to the filter 12, and the output end of the low-noise amplifier 32 is connected to the radio-frequency output terminal 120. The low-noise amplifier 32 amplifies a radio-frequency reception signal (hereinafter simply called a reception signal) of the communication band A input from the antenna terminal 101 or 102.

The input end of the low-noise amplifier 42 is connected to the filter 22, and the output end of the low-noise amplifier 42 is connected to the radio-frequency output terminal 140. The low-noise amplifier 42 amplifies a reception signal of the communication band B input from the antenna terminal 101 or 102.

With the above-described configuration, the radio-frequency circuit 1 is able to execute: (1) a first mode in which a transmission signal of the sub-band Y of the communication band A and a reception signal of the sub-band Z of the communication band B are simultaneously transferred; (2) a second mode in which a transmission signal of the communication band A is transferred and a reception signal of the communication band B is not transferred; and (3) a third mode in which a reception signal of the communication band B is transferred and a transmission signal of the communication band A is not transferred.

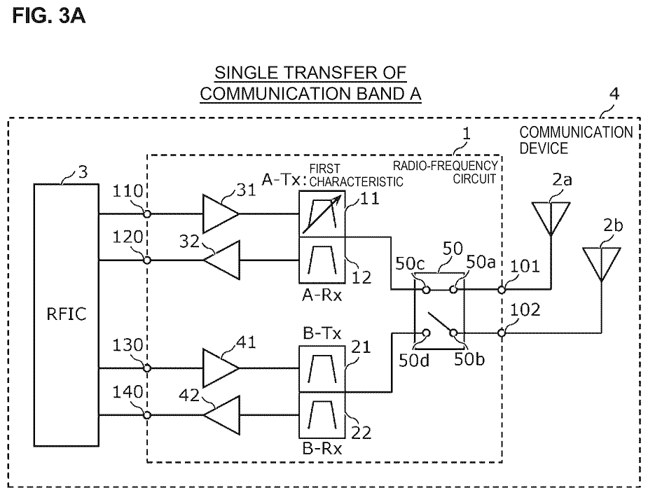

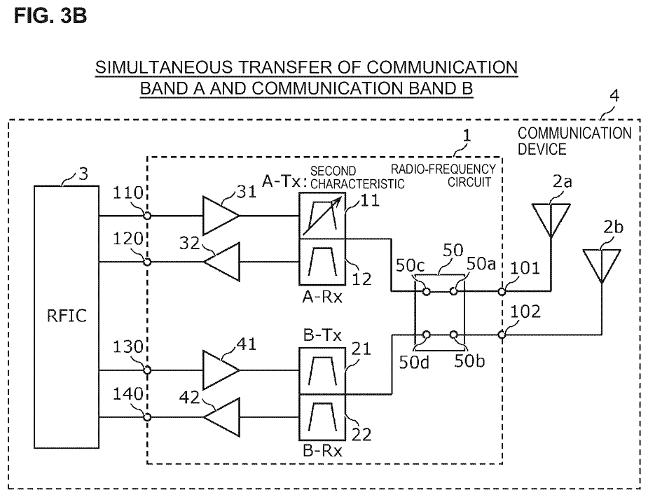

FIG. 3A is a circuit diagram illustrating the connection state of the switch 50 when a signal of the communication band A is singly transferred in the radio-frequency circuit 1 of the embodiment. FIG. 3B is a circuit diagram illustrating the connection state of the switch 50 when a transmission signal of the communication band A and a reception signal of the communication band B are simultaneously transferred in the radio-frequency circuit 1 of the embodiment.

With the above-described configuration, when the second mode is executed, the pass band of the filter 11 is set to the first pass band, so that a transmission signal of the communication band A can be transferred by using the entire range of the transmit band of the communication band A. When the second mode is executed, as illustrated in FIG. 3A, the terminals 50a and 50c of the switch 50 are connected to each other, and the terminals 50b and 50d of the switch 50 are desirably disconnected from each other. This makes it possible to transfer a transmission signal of the communication band A via the filter 11 with a small loss.

When the third mode is executed, a reception signal of the communication band B can be transferred with the use of the filter 22. When the third mode is executed, the terminals 50b and 50d of the switch 50 are connected to each other, and the terminals 50a and 50c of the switch 50 are desirably disconnected from each other. This makes it possible to transfer a reception signal of the communication band B via the filter 22 with a small loss.

When the first mode is executed, the pass band of the filter 11 is set to the second pass band, and as shown in FIG. 3B, the terminals 50a and 50c of the switch 50 are connected to each other, and also, the terminals 50b and 50d of the switch 50 are connected to each other. This can improve the isolation between a transmission signal of the communication band A to pass through the filter 11 and a reception signal of the communication band B to pass through the filter 22 and also reduce the degradation of the reception sensitivity of the communication band B.

In one example of the configuration of a known radio-frequency circuit that executes the first mode, one common-band filter having a pass band including the transmit band of the communication band A and the receive band of the communication band B that are partially overlap each other is used. In this case, however, a transmission signal of the communication band A may leak into the receive path for the communication band B via this common-band filter. This degrades the reception sensitivity of the communication band B.

In another example of the configuration of a known radio-frequency circuit that executes the first mode, a first radio-frequency circuit for transferring a transmission signal of the communication band A and a second radio-frequency circuit for transferring a reception signal of the communication band B are provided and are physically separated from each other. In this case, however, if the first radio-frequency circuit and the second radio-frequency circuit become close to each other, the interference between a transmission signal of the communication band A and a reception signal of the communication band B is intensified, thereby degrading the isolation between the two signals. If a certain distance between the first and second radio-frequency circuits is provided to secure a sufficient isolation, the entire circuit is enlarged.

In contrast, in the radio-frequency circuit 1 of the embodiment, the pass band of the filter 11 can be switched between the first pass band and the second pass band. Even if the filters 11 and 22 are located close to each other, the interference between a transmission signal of the communication band A and a reception signal of the communication band B during the execution of the first mode can be regulated, e.g., reduced, thereby securing the isolation. It is thus possible to provide a small-sized radio-frequency circuit 1 that can simultaneously transfer a transmission signal of the communication band A and a reception signal of the communication band B while reducing the degradation of isolation and reception sensitivity.

In the radio-frequency circuit 1 of the embodiment, the switch 50 (first switch) may be a single pole double throw (SPDT) switch instead of a DPDT switch. In this case, only one antenna is connected to the radio-frequency circuit 1. That is, the first switch includes one antenna connection terminal and first and second terminals and switches between the connection of the antenna connection terminal to the first terminal and the disconnection of the antenna connection terminal from the first terminal and also switches between the connection of the antenna connection terminal to the second terminal and the disconnection of the antenna connection terminal from the second terminal. The antenna connection terminal is connected to the antenna. The first terminal is connected to the filters 11 and 12. The second terminal is connected to the filters 21 and 22.

If the first switch is an SPDT switch, when the radio-frequency circuit 1 executes the second mode, the pass band of the filter 11 is set to the first pass band, so that a transmission signal of the communication band A can be transferred by using the entire range of the transmit band of the communication band A. When the radio-frequency circuit 1 executes the second mode, the antenna connection terminal and the first terminal of the first switch are connected to each other, and the antenna connection terminal and the second terminal of the first switch are desirably disconnected from each other. This makes it possible to transfer a transmission signal of the communication band A via the filter 11 with a small loss.

If the first switch is an SPDT switch, when the radio-frequency circuit 1 executes the third mode, a reception signal of the communication band B can be transferred with the use of the filter 22. When the radio-frequency circuit 1 executes the third mode, the antenna connection terminal and the second terminal of the first switch are connected to each other, and the antenna connection terminal and the first terminal of the first switch are desirably disconnected from each other. This makes it possible to transfer a reception signal of the communication band B via the filter 22 with a small loss.

If the first switch is an SPDT switch, when the radio-frequency circuit 1 executes the first mode, the pass band of the filter 11 is set to the second pass band, and the antenna connection terminal and the first terminal of the first switch are connected to each other, and also, the antenna connection terminal and the second terminal of the first switch are connected to each other. This makes it possible to enhance the isolation between a transmission signal of the communication band A to pass through the filter 11 and a reception signal of the communication band B to pass through the filter 22 and also to regulate the degradation of the reception sensitivity of the communication band B.

For the radio-frequency circuit 1 of the embodiment, the provision of the filters 11 and 22 is necessary, but other circuit elements may be omitted.

In the radio-frequency circuit 1 of the embodiment, the communication band A is one of band 8 (transmit band is 880 to 915 MHz and receive band is 925 to 960 MHz) for 4G-LTE and band n8 (transmit band is 880 to 915 MHz and receive band is 925 to 960 MHz) for 5G-NR, for example. The communication band B is one of band 5 (transmit band is 824 to 849 MHz and receive band is 869 to 894 MHz) for 4G-LTE and band n5 (transmit band is 824 to 849 MHz and receive band is 869 to 894 MHz) for 5G-NR, for example.

### 1.3 Circuit Configuration of Radio-Frequency Circuit of First Modified Example

The pass band of the filter 11 may be fixed, while the pass band of the filter 22 may be variable.

A radio-frequency circuit according to a first modified example includes filters 11, 12, 21, and 22, a switch 50, power amplifiers 31 and 41, low-noise amplifiers 32 and 42, antenna terminals 101 and 102, radio-frequency input terminals 110 and 130, and radio-frequency output terminals 120 and 140. The radio-frequency circuit of the first modified example is different from the radio-frequency circuit 1 of the embodiment in that the pass band of the filter 11 is fixed and the pass band of the filter 22 is variable. The radio-frequency circuit of the first modified example will be described below by mainly referring to the points different from the radio-frequency circuit 1 of the embodiment while omitting an explanation of the same points as those of the radio-frequency circuit 1.

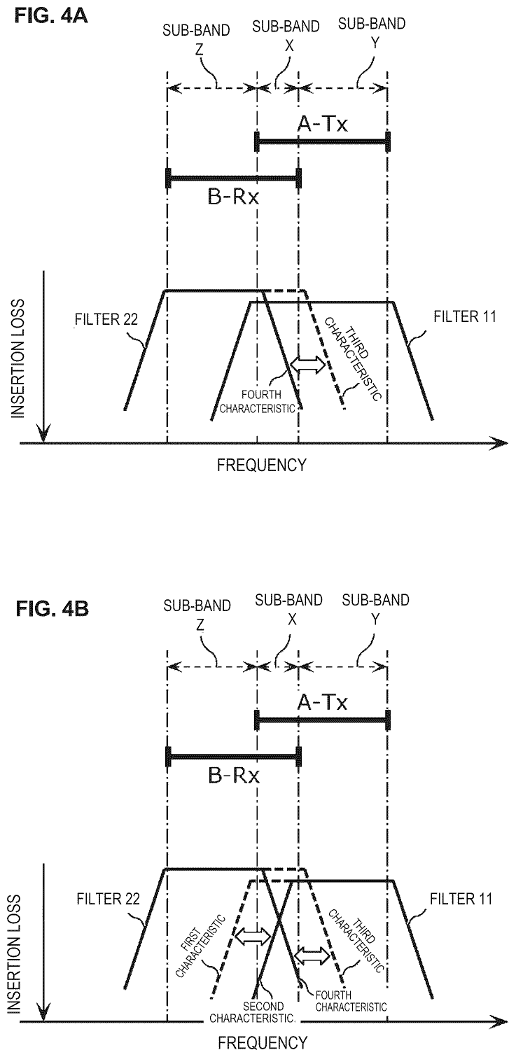

FIG. 4A is a diagram illustrating an example of the relationship between the frequency ranges of the communication band A and the communication band B to be applied to the radio-frequency circuit of the first modified example and an example of the bandpass characteristics of the filters 11 and 22. In the first modified example, the communication band A is an example of the second communication band, while the communication band B is an example of the first communication band. The communication band A and the communication band B are a combination of bands that can be used for simultaneous communication. As shown in FIG. 4A, the frequency range of the transmit band (A-Tx) of the communication band A and that of the receive band (B-Rx) of the communication band B partially overlap each other.

In the first modified example, the receive band of the communication band B is an example of the first frequency band, while the transmit band of the communication band A is an example of the second frequency band. As shown in FIG. 4A, the receive band of the communication band B includes a sub-band X (first sub-band) that overlaps the transmit band of the communication band A and a sub-band Z (second sub-band) that does not overlap the transmit band of the communication band A. As also shown in FIG. 4A, the transmit band of the communication band A includes the sub-band X (first sub-band) that overlaps the receive band of the communication band B and a sub-band Y (third sub-band) that does not overlap the receive band of the communication band B.

The filter 22 is an example of the first filter. The filter 22 has a pass band including the receive band (first frequency band) of the communication band B. More specifically, the pass band of the filter 22 can be switched between a first pass band including the sub-band X and the sub-band Z and a second pass band including the sub-band Z. The second pass band is narrower than the first pass band. In other words, the filter 22 can be switched between a third characteristic representing the first pass band and a fourth characteristic representing the second pass band. One end of the filter 22 is connected to the terminal 50d (first terminal) of the switch 50 (first switch), and the other end of the filter 22 is connected to the input end of the low-noise amplifier 42.

The filter 11 is an example of the second filter. The filter 11 has a pass band including the transmit band (second frequency band) of the communication band A. One end of the filter 11 is connected to the terminal 50c (second terminal) of the switch 50 (first switch), and the other end of the filter 11 is connected to the output end of the power amplifier 31.

The switch 50 is an example of the first switch. The switch 50 includes the terminal 50a (first antenna connection terminal), terminal 50b (second antenna connection terminal), terminal 50c (second terminal), and terminal 50d (first terminal).

With the above-described configuration, the radio-frequency circuit of the first modified example is able to execute: (1) a first mode in which a transmission signal of the sub-band Y of the communication band A and a reception signal of the sub-band Z of the communication band B are simultaneously transferred; (2) a second mode in which a transmission signal of the communication band A is transferred and a reception signal of the communication band B is not transferred; and (3) a third mode in which a reception signal of the communication band B is transferred and a transmission signal of the communication band A is not transferred.

With the above-described configuration, when the third mode is executed, the pass band of the filter 22 is set to the first pass band, so that a reception signal of the communication band B can be transferred by using the entire range of the receive band of the communication band B. When the second mode is executed, a transmission signal of the communication band A can be transferred with the use of the filter 11. When the first mode is executed, the pass band of the filter 22 is set to the second pass band. This can improve the isolation between a reception signal of the communication band B to pass through the filter 22 and a transmission signal of the communication band A to pass through the filter 11 and also reduce the degradation of the reception sensitivity of the communication band B.

In the radio-frequency circuit of the first modified example, the pass band of the filter 22 is switchable between the first pass band and the second pass band. Even if the filters 11 and 22 are located close to each other, the interference between a transmission signal of the communication band A and a reception signal of the communication band B during the execution of the first mode can be regulated, thereby securing the isolation. It is thus possible to provide a small-sized radio-frequency circuit that can simultaneously transfer a transmission signal of the communication band A and a reception signal of the communication band B while reducing the degradation of isolation and reception sensitivity.

In the radio-frequency circuit of the first modified example, the communication band A is one of band 8 for 4G-LTE and band n8 for 5G-NR, for example, while the communication band B is one of band 5 for 4G-LTE and band n5 for 5G-NR, for example.

### 1.4 Circuit Configuration of Radio-frequency Circuit of Second Modified Example

The pass band of the filter 11 and that of the filter 22 may be both variable.

A radio-frequency circuit according to a second modified example includes filters 11, 12, 21, and 22, a switch 50, power amplifiers 31 and 41, low-noise amplifiers 32 and 42, antenna terminals 101 and 102, radio-frequency input terminals 110 and 130, and radio-frequency output terminals 120 and 140. The radio-frequency circuit of the second modified example is different from the radio-frequency circuit 1 of the embodiment in that the pass band of the filter 11 and that of the filter 22 are both variable. The radio-frequency circuit of the second modified example will be described below by mainly referring to the points different from the radio-frequency circuit 1 of the embodiment while omitting an explanation of the same points as those of the radio-frequency circuit 1.

FIG. 4B is a diagram illustrating an example of the relationship between the frequency ranges of the communication band A and the communication band B to be applied to the radio-frequency circuit of the second modified example and an example of the bandpass characteristics of the filters 11 and 22. In the second modified example, the communication band A is an example of the first communication band, while the communication band B is an example of the second communication band. The communication band A and the communication band B are a combination of bands that can be used for simultaneous communication. As shown in FIG. 4B, the frequency range of the transmit band (A-Tx) of the communication band A and that of the receive band (B-Rx) of the communication band B partially overlap each other.

In the second modified example, the transmit band of the communication band A is an example of the first frequency band, while the receive band of the communication band B is an example of the second frequency band. As shown in FIG. 4B, the transmit band of the communication band A includes a sub-band X (first sub-band) that overlaps the receive band of the communication band B and a sub-band Y (second sub-band) that does not overlap the receive band of the communication band B. As also shown in FIG. 4B, the receive band of the communication band B includes the sub-band X (first sub-band) that overlaps the transmit band of the communication band A and a sub-band Z (third sub-band) that does not overlap the transmit band of the communication band A.

The filter 11 is an example of the first filter. The filter 11 has a pass band including the transmit band (first frequency band) of the communication band A. More specifically, the pass band of the filter 11 can be switched between a first pass band including the sub-band X and the sub-band Y and a second pass band including the sub-band Y. The second pass band is narrower than the first pass band. In other words, the filter 11 can be switched between a first characteristic representing the first pass band and a second characteristic representing the second pass band. One end of the filter 11 is connected to the terminal 50c (first terminal) of the switch 50 (first switch), and the other end of the filter 11 is connected to the output end of the power amplifier 31.

The filter 22 is an example of the second filter.

The filter 22 has a pass band including the receive band (second frequency band) of the communication band B. More specifically, the pass band of the filter 22 can be switched between a third pass band including the sub-band X and the sub-band Z and a fourth pass band including the sub-band Z. The fourth pass band is narrower than the third pass band. In other words, the filter 22 can be switched between a third characteristic representing the third pass band and a fourth characteristic representing the fourth pass band. One end of the filter 22 is connected to the terminal 50d (second terminal) of the switch 50 (first switch), and the other end of the filter 22 is connected to the input end of the low-noise amplifier 42.

With the above-described configuration, the radio-frequency circuit of the second modified example is able to execute: (1) a first mode in which a transmission signal of the sub-band Y of the communication band A and a reception signal of the sub-band Z of the communication band B are simultaneously transferred; (2) a second mode in which a transmission signal of the communication band A is transferred and a reception signal of the communication band B is not transferred; and (3) a third mode in which a reception signal of the communication band B is transferred and a transmission signal of the communication band A is not transferred.

With the above-described configuration, when the second mode is executed, the pass band of the filter 11 is set to the first pass band, so that a transmission signal of the communication band A can be transferred by using the entire range of the transmit band of the communication band A. When the third mode is executed, a reception signal of the communication band B can be transferred with the use of the filter 22. When the first mode is executed, the pass band of the filter 11 is set to the second pass band, while the pass band of the filter 22 is set to the fourth pass band. This makes it possible to improve the isolation by further reducing the interference between a transmission signal of the communication band A to pass through the filter 11 and a reception signal of the communication band B to pass through the filter 22 and also to reduce the degradation of the reception sensitivity of a reception signal of the communication band B.

In the radio-frequency circuit of the second modified example, the pass band of the filter 11 and that of the filter 22 are both variable. Even if the filters 11 and 22 are located close to each other, a high isolation between a transmission signal of the communication band A and a reception signal of the communication band B during the execution of the first mode can be secured. It is thus possible to provide a small-sized radio-frequency circuit that can simultaneously transfer a transmission signal of the communication band A and a reception signal of the communication band B while reducing the degradation of isolation and reception sensitivity.

In the radio-frequency circuit of the second modified example, the communication band A is one of band 8 for 4G-LTE and band n8 for 5G-NR, for example, while the communication band B is one of band 5 for 4G-LTE and band n5 for 5G-NR, for example.

### 1.5 Example of Circuit Configuration of Filter 11

Examples of the circuit configuration of the filter 11 having a variable pass band will be discussed below.

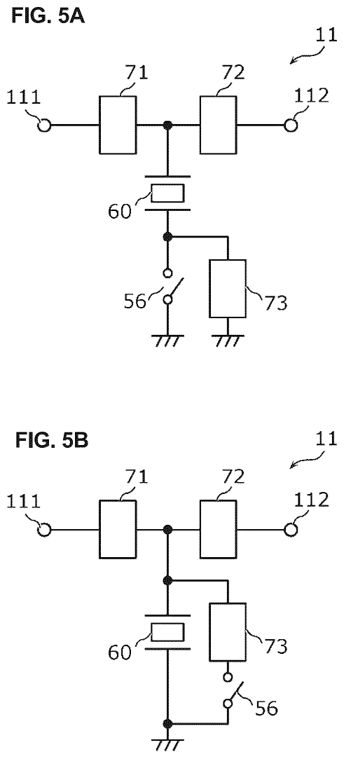

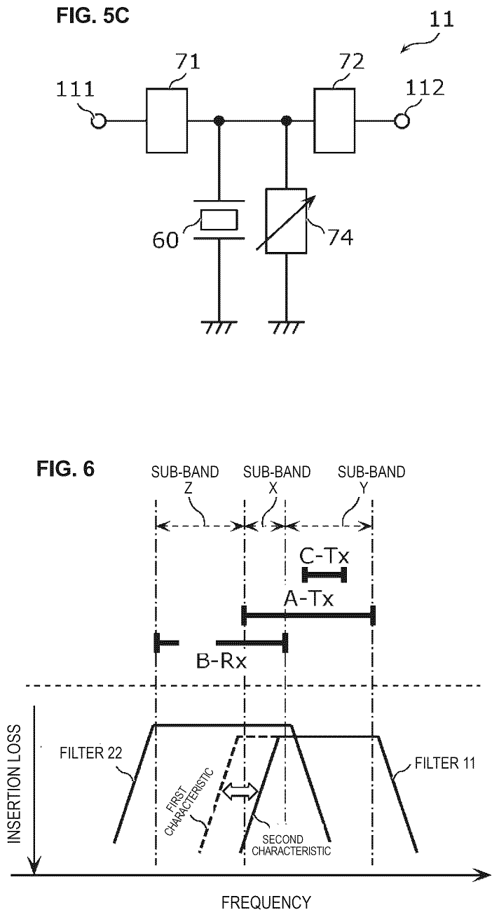

FIG. 5A illustrates a first example of the circuit configuration of the filter 11 in the embodiment. FIG. 5B illustrates a second example of the circuit configuration of the filter 11 in the embodiment. FIG. 5C illustrates a third example of the circuit configuration of the filter 11 in the embodiment.

The filter 11 shown in FIG. 5A includes circuit elements 71, 72, and 73, a switch 56, and an acoustic wave resonator 60. The circuit elements 71 and 72 are connected in series with each other on a series arm path that links terminals 111 and 112 with each other. The acoustic wave resonator 60 is connected between a ground and a node between the circuit elements 71 and 72. The switch 56 is connected in series with the acoustic wave resonator 60 on a parallel arm path that links the above-described node and a ground with each other. The circuit element 73 is connected in parallel with the switch 56. Each of the circuit elements 71, 72, and 73 is one of an inductor, a capacitor, and an acoustic wave resonator, for example. The resonance bandwidth (frequency difference between the anti-resonant frequency and the resonant frequency) of the acoustic wave resonator 60 is switchable in accordance with whether the switch 56 is ON or OFF. With this circuit configuration in the first example, the pass band of the filter 11 can be switched between the first pass band and the second pass band in accordance with whether the switch 56 is ON or OFF.

The filter 11 shown in FIG. 5B includes circuit elements 71, 72, and 73, a switch 56, and an acoustic wave resonator 60. The circuit elements 71 and 72 are connected in series with each other on a series arm path that links terminals 111 and 112 with each other. The acoustic wave resonator 60 is connected between a ground and a node between the circuit elements 71 and 72. A series connection circuit of the switch 56 and the circuit element 73 is connected in parallel with the acoustic wave resonator 60. Each of the circuit elements 71, 72, and 73 is one of an inductor, a capacitor, and an acoustic wave resonator, for example. The resonance bandwidth of the acoustic wave resonator 60 is switchable in accordance with whether the switch 56 is ON or OFF. With this circuit configuration in the second example, the pass band of the filter 11 can be switched between the first pass band and the second pass band in accordance with whether the switch 56 is ON or OFF.

The filter 11 shown in FIG. 5C includes circuit elements 71 and 72, a variable circuit element 74, and an acoustic wave resonator 60. The circuit elements 71 and 72 are connected in series with each other on a series arm path that links terminals 111 and 112 with each other. The acoustic wave resonator 60 is connected between a ground and a node between the circuit elements 71 and 72. The variable circuit element 74 is connected between a ground and a node between the circuit elements 71 and 72. Each of the circuit elements 71 and 72 is one of an inductor, a capacitor, and an acoustic wave resonator, for example. The variable circuit element 74 is one of a variable inductor and a variable capacitor, for example. The variable circuit element 74 may be constituted by a switch and an element selected from one of an inductor, a capacitor, and an acoustic wave resonator. The resonance bandwidth of the acoustic wave resonator 60 is switchable in accordance with a change in the physical quantity (inductance or capacitance) of the variable circuit element 74. With this circuit configuration in the third example, the pass band of the filter 11 can be switched between the first pass band and the second pass band in accordance with a change in the physical quantity of the variable circuit element 74.

### 1.6 Circuit Configuration of Radio-Frequency Circuit of Third Modified Example

The pass band of the filter 11 may include one of the transmit band and the receive band of communication band C (third communication band).

A radio-frequency circuit according to a third modified example includes filters 11, 12, 21, and 22, a switch 50, power amplifiers 31 and 41, low-noise amplifiers 32 and 42, antenna terminals 101 and 102, radio-frequency input terminals 110 and 130, and radio-frequency output terminals 120 and 140. The radio-frequency circuit of the third modified example is different from the radio-frequency circuit 1 of the embodiment only in that the pass band of the filter 11 includes the transmit band of the communication band C (third communication band). The radio-frequency circuit of the third modified example will be described below by mainly referring to the points different from the radio-frequency circuit 1 of the embodiment while omitting an explanation of the same points as those of the radio-frequency circuit 1.

FIG. 6 is a diagram illustrating an example of the relationships between the frequency ranges of the communication band A, communication band B, and communication band C to be applied to the radio-frequency circuit of the third modified example and an example of the bandpass characteristics of the filters 11 and 22. In the third modified example, the communication band A is an example of the first communication band, while the communication band B is an example of the second communication band. The communication band A and the communication band B are a combination of bands that can be used for simultaneous communication. As shown in FIG. 6, the frequency range of the transmit band (A-Tx) of the communication band A and that of the receive band (B-Rx) of the communication band B partially overlap each other. The transmit band (C-Tx) of the communication band C partially overlaps the sub-band Y of the transmit band of the communication band A and does not overlap the sub-band X.

The filter 11 is an example of the first filter. The filter 11 has a pass band including the transmit band (first frequency band) of the communication band A and the transmit band of the communication band C.

With the above-described configuration, the radio-frequency circuit of the third modified example is able to execute: (1) a first mode in which a transmission signal of the sub-band Y of the communication band A and a reception signal of the sub-band Z of the communication band B are simultaneously transferred; (2) a second mode in which a transmission signal of the communication band A is transferred and a reception signal of the communication band B is not transferred; (3) a third mode in which a reception signal of the communication band B is transferred and a transmission signal of the communication band A is not transferred; and (4) a fourth mode in which a transmission signal of the communication band C is transferred.

When the fourth mode is executed, the pass band of the filter 11 is set to the second pass band, so that the quality of a transmission signal of the communication band C to pass through the filter 11 can be improved.

In the radio-frequency circuit of the third modified example, the transmit band of the communication band C may overlap the sub-band X. In this case, when the fourth mode is executed, the pass band of the filter 11 is set to the first pass band, so that a transmission signal of the communication band C can be transferred by using the entire range of the transmit band of the communication band C.

In the radio-frequency circuit of the third modified example, instead of the transmit band of the communication band C, the receive band of the communication band C may overlap the transmit band of the communication band A. In this case, when a reception signal of the communication band C is transferred, the pass band of the filter 11 is set to the second pass band, so that the degradation of the reception sensitivity of the communication band C can be regulated.

In the radio-frequency circuit of the first modified example, the pass band of the filter 22 may include one of the transmit band and the receive band of the communication band C (third communication band). In this case, when a transmission signal or a reception signal of the communication band C is transferred, the filter 22 is set to the third pass band or the fourth pass band, so that the quality of the transmission signal of the communication band C can be improved or the degradation of the reception sensitivity of the communication band C can be regulated.

In the radio-frequency circuit of the second modified example, the pass band of the filter 11 or the filter 22 may include one of the transmit band and the receive band of the communication band C (third communication band). In this case, when a transmission signal or a reception signal of the communication band C is transferred, the pass band of the filter 11 is set to the first pass band or the second pass band, or the pass band of the filter 22 is set to the third pass band or the fourth pass band. This can improve the quality of the transmission signal of the communication band C or regulate the degradation of the reception sensitivity of the communication band C.

In the radio-frequency circuit of the third modified example, the communication band A is one of band 8 for 4G-LTE and band n8 for 5G-NR, for example. The communication band B is one of band 5 for 4G-LTE and band n5 for 5G-NR, for example. The communication band C is band n106 (transmit band is 896 to 901 MHz and receive band is 935 to 940 MHz) for 5G-NR, for example.

### 1.7 Circuit Configuration of Radio-Frequency Circuit 1A of Fourth Modified Example

In a fourth modified example, an explanation will be given of a radio-frequency circuit that transfers a signal of communication band D, which overlaps neither of the communication band A nor the communication band B, simultaneously with the communication band A and the communication band B.

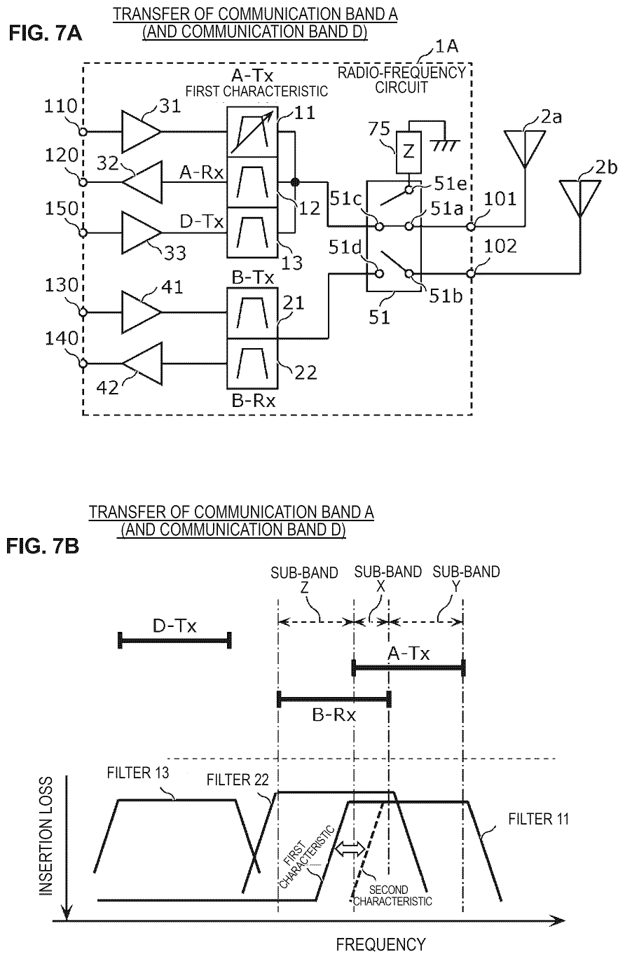

FIG. 7A is a circuit diagram illustrating a first connection state of a radio-frequency circuit 1A according to the fourth modified example. FIG. 7B is a diagram illustrating an example of the relationships between the frequency ranges of the communication bands to be applied to the radio-frequency circuit 1A of the fourth modified example and an example of the bandpass characteristics of the filters in the first connection state.

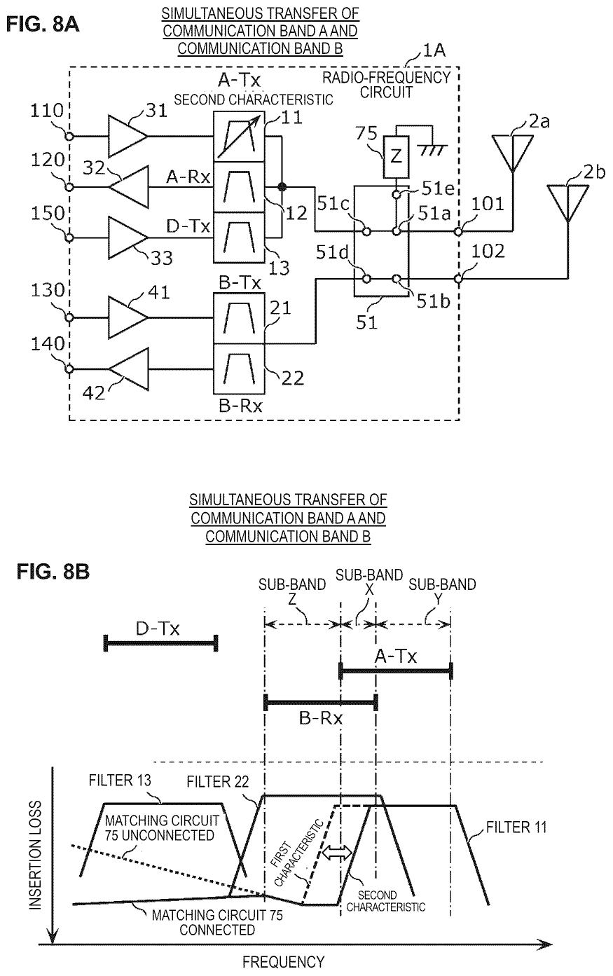

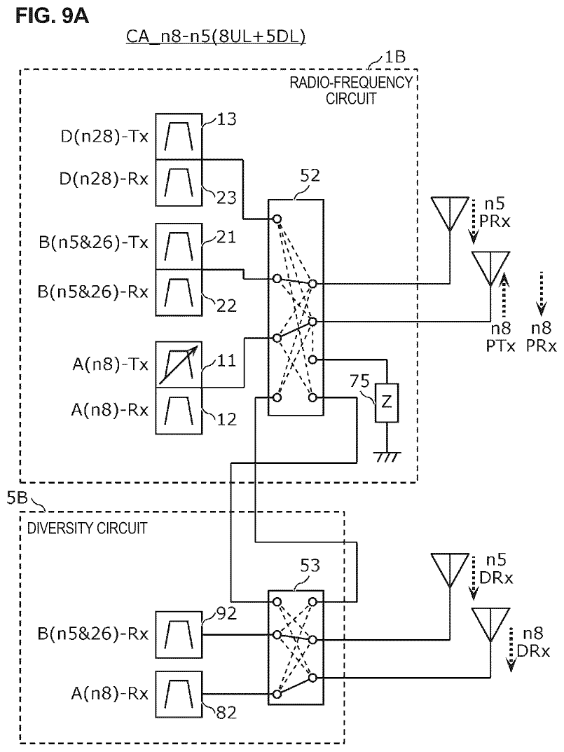

FIG. 8A is a circuit diagram illustrating a second connection state of the radio-frequency circuit 1A according to the fourth modified example. FIG. 8B is a diagram illustrating an example of the relationships between the frequency ranges of the communication bands to be applied to the radio-frequency circuit 1A of the fourth modified example and an example of the bandpass characteristics of the filters in the second connection state.

As illustrated in FIGS. 7A and 8A, the radio-frequency circuit 1A according to the fourth modified example includes filters 11, 12, 13, 21, and 22, a switch 51, a matching circuit 75, power amplifiers 31, 33, and 41, low-noise amplifiers 32 and 42, antenna terminals 101 and 102, radio-frequency input terminals 110, 130, and 150, and radio-frequency output terminals 120 and 140. The radio-frequency circuit 1A of the fourth modified example is different from the radio-frequency circuit 1 of the embodiment in that circuit elements for transferring a signal of the communication band D are added. The radio-frequency circuit 1A of the fourth modified example will be described below by mainly referring to the points different from the radio-frequency circuit 1 of the embodiment while omitting an explanation of the same points as those of the radio-frequency circuit 1.

The antenna terminal 101 is connected to an antenna 2a and a terminal 51a of the switch 51. The antenna terminal 102 is connected to an antenna 2b and a terminal 51b of the switch 51. The radio-frequency input terminal 150 is connected to the power amplifier 33 and is used for receiving a radio-frequency transmission signal.

In the fourth modified example, the communication band A is an example of the first communication band, the communication band B is an example of the second communication band, and the communication band D is an example of a fourth communication band. The communication band A, the communication band B, and the communication band D are a combination of bands that can be used for simultaneous communication. As shown in FIGS. 7B and 8B, the frequency range of the transmit band (A-Tx) of the communication band A and that of the receive band (B-Rx) of the communication band B partially overlap each other. The frequency range of the transmit band (D-Tx) of the communication band D overlaps neither of the transmit band (A-Tx) of the communication band A nor the receive band (B-Rx) of the communication band B.

In the fourth modified example, the transmit band of the communication band A is an example of the first frequency band; the receive band of the communication band B is an example of the second frequency band; and the transmit band of the communication band D is an example of a third frequency band. As shown in FIGS. 7B and 8B, the transmit band of the communication band A includes a sub-band X (first sub-band) that overlaps the receive band of the communication band B and a sub-band Y (second sub-band) that does not overlap the receive band of the communication band B. The receive band of the communication band B includes the sub-band X (first sub-band) that overlaps the transmit band of the communication band A and a sub-band Z (third sub-band) that does not overlap the transmit band of the communication band A.

The filter 11 is an example of the first filter. The filter 11 can be switched between a first pass band including the sub-band X and the sub-band Y and a second pass band including the sub-band Y. The second pass band is narrower than the first pass band. In other words, the filter 11 can be switched between a first characteristic representing the first pass band and a second characteristic representing the second pass band. One end of the filter 11 is connected to a terminal 51c (first terminal) of the switch 51 (first switch), and the other end of the filter 11 is connected to the output end of the power amplifier 31.

The filter 22 is an example of the second filter and has a pass band including the receive band (second frequency band) of the communication band B. One end of the filter 22 is connected to a terminal 51d (second terminal) of the switch 51 (first switch), and the other end of the filter 22 is connected to the input end of the low-noise amplifier 42.

The filter 12 has a pass band including the receive band of the communication band A. One end of the filter 12 is connected to the terminal 51c of the switch 51, and the other end of the filter 12 is connected to the input end of the low-noise amplifier 32.

The filter 21 has a pass band including the transmit band of the communication band B. One end of the filter 21 is connected to the terminal 51d of the switch 51, and the other end of the filter 21 is connected to the output end of the power amplifier 41.

The filter 13 is an example of a third filter and has a pass band including the transmit band (third frequency band) of the communication band D. One end of the filter 13 is connected to the terminal 51c (first terminal) of the switch 51 (first switch), and the other end of the filter 13 is connected to the output end of the power amplifier 33.

The matching circuit 75 is an example of an impedance matching circuit and is connected between a terminal 51e of the switch 51 and a ground. The matching circuit 75 is constituted by at least one of an inductor, a capacitor, and an acoustic wave resonator, for example.

The switch 51 is an example of the first switch and a second switch. The switch 51 includes the terminal 51a (first antenna connection terminal), terminal 51b (second antenna connection terminal), terminal 51c (first terminal), terminal 51d (second terminal), and terminal 51e. The terminals 51a, 51b, 51c, and 51d of the switch 51 form the first switch, and the terminals 51a and 51e of the switch 51 form the second switch. The switch 51 switches between the connection of the terminal 51a to the terminal 51c and the disconnection of the terminal 51a from the terminal 51c and switches between the connection of the terminal 51a to the terminal 51d and the disconnection of the terminal 51a from the terminal 51d. The switch 51 also switches between the connection of the terminal 51b to the terminal 51c and the disconnection of the terminal 51b from the terminal 51c and switches between the connection of the terminal 51b to the terminal 51d and the disconnection of the terminal 51b from the terminal 51d. The switch 51 also switches between the connection of the terminal 51a to the terminal 51e and the disconnection of the terminal 51a from the terminal 51e. The switch 51 may be a switch circuit constituted by the first switch including the terminals 51a, 51b, 51c, and 51d and the second switch including the terminals 51a and 51e.

The terminal 51a is connected to the antenna terminal 101. The terminal 51b is connected to the antenna terminal 102. The terminal 51c is connected to the filters 11, 12, and 13. The terminal 51d is connected to the filters 21 and 22. The terminal 51e is connected to the matching circuit 75. With this connection configuration, the switch 51 switches between the connection of the antenna 2a to the filters 11 through 13 and the disconnection of the antenna 2a from the filters 11 through 13 and switches between the connection of the antenna 2a to the filters 21 and 22 and the disconnection of the antenna 2a from the filters 21 and 22. The switch 51 also switches between the connection of the antenna 2b to the filters 11 through 13 and the disconnection of the antenna 2b from the filters 11 through 13 and switches between the connection of the antenna 2b to the filters 21 and 22 and the disconnection of the antenna 2b from the filters 21 and 22. The switch 51 also switches between the connection of the antenna 2a to the matching circuit 75 and the disconnection of the antenna 2a from the matching circuit 75. The switch 51 may switch between the connection of the terminal 51c to the terminal 51e and the disconnection of the terminal 51c from the terminal 51e, instead of switching between the connection of the terminal 51a to the terminal 51e and the disconnection of the terminal 51a from the terminal 51e. In this case, the switch 51 switches between the connection of the matching circuit 75 to the filters 11 through 13 and the disconnection of the matching circuit 75 from the filters 11 through 13, instead of switching between the connection of the antenna 2a to the matching circuit 75 and the disconnection of the antenna 2a from the matching circuit 75.

The output end of the power amplifier 33 is connected to the filter 13, and the input end of the power amplifier 33 is connected to the radio-frequency input terminal 150. The power amplifier 33 amplifies a transmission signal of the communication band D input from the radio-frequency input terminal 150.

With the above-described configuration, the radio-frequency circuit 1A is able to execute: (1) a fifth mode in which a transmission signal of the sub-band Y of the communication band A, a reception signal of the sub-band Z of the communication band B, and a transmission signal of the communication band D are simultaneously transferred; (2) a sixth mode in which a transmission signal of the communication band A and a transmission signal of the communication band D are transferred and a reception signal of the communication band B is not transferred; and (3) a third mode in which a reception signal of the communication band B is transferred and a transmission signal of the communication band A is not transferred.

As illustrated in FIGS. 7A and 7B, when the sixth mode is executed, the pass band of the filter 11 is set to the first pass band, so that a transmission signal of the communication band A can be transferred by using the entire range of the transmit band of the communication band A. When the sixth mode is executed, the terminals 51a and 51c of the switch 51 are connected to each other, and the terminal 51d is connected to neither of the terminal 51a nor the terminal 51b. The terminals 51a and 51e are not connected to each other.

As illustrated in FIGS. 8A and 8B, when the fifth mode is executed, the pass band of the filter 11 is set to the second pass band, and the terminals 51a and 51c of the switch 51 are connected to each other, and the terminals 51b and 51d of the switch 51 are connected to each other. This can improve the isolation between a transmission signal of the communication band A to pass through the filter 11 and a reception signal of the communication band B to pass through the filter 22 and also reduce the degradation of the reception sensitivity of the communication band B.

When the sixth mode is switched to the fifth mode, the pass band of the filter 11 is changed from the first pass band to the second pass band. As shown in FIGS. 7B and 8B, this changes the attenuation characteristics of the filter 11 in the transmit band of the communication band D. In this case, if the matching circuit 75 is unconnected, the attenuation characteristics of the filter 11 are changed, as indicated by the broken line in FIG. 8B. To address this issue, when the sixth mode is switched to the fifth mode, the terminals 51a and 51e are connected to each other so as to connect the matching circuit 75 to the filters 11 through 13. Then, the attenuation characteristics of the filter 11 can be adjusted in response to the switching of the pass band of the filter 11. This can improve the attenuation characteristics of the filter 11 in the transmit band of the communication band D, as indicated by the solid line in FIG. 8B.

When a signal of the communication band A and a signal of the communication band B whose frequency bands partially overlap each other are simultaneously transferred, the degradation of isolation and reception sensitivity can be regulated. Additionally, the communication band D can be transferred simultaneously with the communication band A and the communication band B with a small loss.

In the radio-frequency circuit 1A of the fourth modified example, the communication band A is one of band 8 for 4G-LTE and band n8 for 5G-NR, for example. The communication band B is one of band 5 for 4G-LTE and band n5 for 5G-NR, for example. The communication band D is one of band 28 (transmit band is 703 to 748 MHz and receive band is 758 to 803 MHz) for 4G-LTE, band 12 (transmit band is 699 to 716 MHz and receive band is 729 to 746 MHz) for 4G-LTE, band n28 (transmit band is 703 to 748 MHz and receive band is 758 to 803 MHz) for 5G-NR, and band n12 (transmit band is 699 to 716 MHz and receive band is 729 to 746 MHz) for 5G-NR, for example.

### 1.8 Circuit Configuration of Radio-Frequency Circuit 1B of Fifth Modified Example

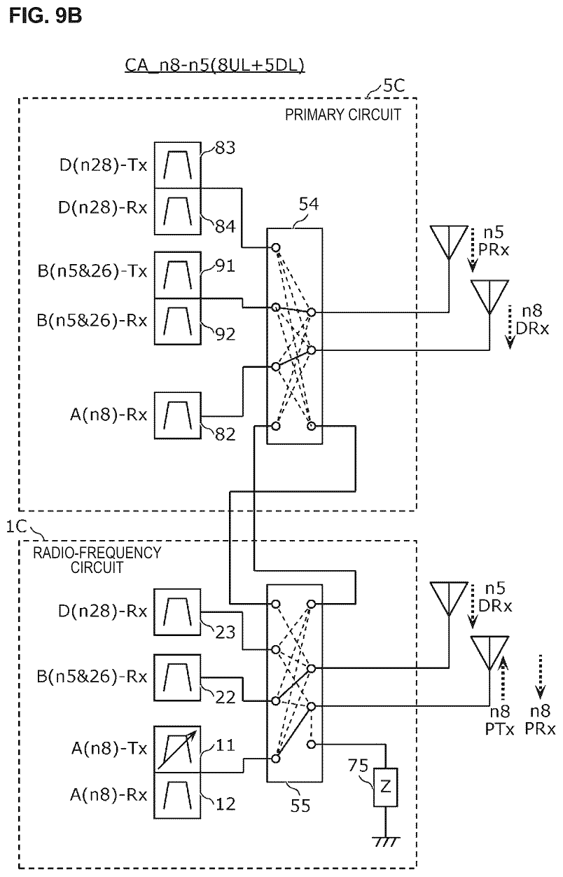

FIG. 9A is a circuit diagram of a radio-frequency circuit 1B and a diversity circuit 5B according to a fifth modified example. The radio-frequency circuit 1B, which is an example of the radio-frequency circuit according to an embodiment of the disclosure, is connected to the diversity circuit 5B. As illustrated in FIG. 9A, the radio-frequency circuit 1B of the fifth modified example includes filters 11, 12, 13, 21, 22, and 23, a switch 52, and a matching circuit 75.

The filter 11 is an example of the first filter and has a pass band including the transmit band of band n8 (communication band A) for 5G-NR. Band n8 for 5G-NR is an example of the first communication band.

The filter 12 has a pass band including the receive band of band n8 for 5G-NR.

The filter 21 has a pass band including the transmit band of band n5 (communication band B) for 5G-NR and the transmit band of band n26 (transmit band is 814 to 849 MHz and receive band is 859 to 894 MHz) for 5G-NR. Band n5 for 5G-NR is an example of the second communication band.

The filter 22 is an example of the second filter and has a pass band including the receive band of band n5 for 5G-NR and the receive band of band n26 for 5G-NR.

The filter 13 has a pass band including the transmit band of band n28 (communication band D) for 5G-NR or the transmit band of band n12 (communication band D) for 5G-NR.

The filter 23 has a pass band including the receive band of band n28 for 5G-NR or the receive band of band n12 for 5G-NR.

In the fifth modified example, band n8 and band n5 are a combination of bands that can be used for simultaneous communication. The frequency range of the transmit band of band n8 and that of the receive band of band n5 partially overlap each other. The transmit band of band n8 is an example of the first frequency band, while the receive band of band n5 is an example of the second frequency band. The transmit band of band n8 includes a sub-band X (first sub-band) that overlaps the receive band of band n5 and a sub-band Y (second sub-band) that does not overlap the receive band of band n5. The receive band of band n5 includes the sub-band X (first sub-band) that overlaps the transmit band of band n8 and a sub-band Z (third sub-band) that does not overlap the transmit band of band n8.

The pass band of the filter 11 can be switched between a first pass band including the sub-band X and the sub-band Y and a second pass band including the sub-band Y. The second pass band is narrower than the first pass band. One end of the filter 11 is connected to a first selection terminal of the switch 52.

The filter 22 has a pass band including the sub-band X and the sub-band Z. One end of the filter 22 is connected to a second selection terminal of the switch 52.

The matching circuit 75 is an example of the impedance matching circuit and is connected between a third selection terminal of the switch 52 and a ground.

The switch 52 is an example of the first switch. The switch 52 switches between the connection of a first antenna to the filters 11 and 12 and the disconnection of the first antenna from the filters 11 and 12, switches between the connection of the first antenna to the filters 21 and 22 and the disconnection of the first antenna from the filters 21 and 22, and switches between the connection of the first antenna to the filters 13 and 23 and the disconnection of the first antenna from the filters 13 and 23. The switch 52 also switches between the connection of the first antenna to the diversity circuit 5B and the disconnection of the first antenna from the diversity circuit 5B. The switch 52 switches between the connection of a second antenna to the filters 11 and 12 and the disconnection of the second antenna from the filters 11 and 12, switches between the connection of the second antenna to the filters 21 and 22 and the disconnection of the second antenna from the filters 21 and 22, and switches between the connection of the second antenna to the filters 13 and 23 and the disconnection of the second antenna from the filters 13 and 23. The switch 52 also switches between the connection of the second antenna to the diversity circuit 5B and the disconnection of the second antenna from the diversity circuit 5B. The switch 52 also switches between the connection of the second antenna to the matching circuit 75 and the disconnection of the second antenna from the matching circuit 75.

As illustrated in FIG. 9A, the diversity circuit 5B includes filters 82 and 92 and a switch 53.

The filter 92 has a pass band including the receive band of band n5 for 5G-NR and the receive band of band n26 for 5G-NR.

The filter 82 has a pass band including the receive band of band n8 for 5G-NR.

The switch 53 switches between the connection of a third antenna to the filter 92 and the disconnection of the third antenna from the filter 92 and also switches between the connection of the third antenna to the filter 82 and the disconnection of the third antenna from the filter 82. The switch 53 also switches between the connection of the third antenna to the radio-frequency circuit 1B and the disconnection of the third antenna from the radio-frequency circuit 1B. The switch 53 switches between the connection of a fourth antenna to the filter 92 and the disconnection of the fourth antenna from the filter 92 and also switches between the connection of the fourth antenna to the filter 82 and the disconnection of the fourth antenna from the filter 82. The switch 53 switches between the connection of the fourth antenna to the radio-frequency circuit 1B and the disconnection of the fourth antenna from the radio-frequency circuit 1B.

With the above-described configuration, the radio-frequency circuit 1B and the diversity circuit 5B are able to execute: (1) a first mode in which a transmission signal of the sub-band Y of the communication band A and a reception signal of the sub-band Z of the communication band B are simultaneously transferred; (2) a second mode in which a transmission signal of the communication band A is transferred and a reception signal of the communication band B is not transferred; and (3) a third mode in which a reception signal of the communication band B is transferred and a transmission signal of the communication band A is not transferred.

With the above-described configuration, when the second mode is executed, the pass band of the filter 11 is set to the first pass band, so that a transmission signal of the communication band A can be transferred by using the entire range of the transmit band of the communication band A. When the second mode is executed, the filter 11 and the first antenna or the second antenna are connected to each other.

When the third mode is executed, a reception signal of the communication band B can be transferred with the use of the filter 22. When the third mode is executed, the filter 22 and the first antenna or the second antenna are connected to each other.

When the first mode is executed, the pass band of the filter 11 is set to the second pass band, and as shown in FIG. 9A, the filter 11 and the second antenna are connected to each other, and the filter 22 and the first antenna are connected to each other. The first antenna or the second antenna and the matching circuit 75 may be connected to each other. This can improve the isolation between a transmission signal of the communication band A to pass through the filter 11 and a reception signal of the communication band B to pass through the filter 22 and also reduce the degradation of the reception sensitivity of the communication band B.

When the first mode is executed, the filter 82 and the fourth antenna may be connected to each other, and the filter 92 and the third antenna may be connected to each other, as shown in FIG. 9A. This enables the diversity circuit 5B to receive a reception signal of the communication band A and a reception signal of the communication band B.

### 1.9 Circuit Configuration of Radio-Frequency Circuit 1C of Sixth Modified Example

FIG. 9B is a circuit diagram of a radio-frequency circuit 1C and a primary circuit 5C according to a sixth modified example. The radio-frequency circuit 1C, which is an example of the radio-frequency circuit according to an embodiment of the disclosure, is connected to the primary circuit 5C. As illustrated in FIG. 9B, the radio-frequency circuit 1C of the sixth modified example includes filters 11, 12, 22, and 23, a switch 55, and a matching circuit 75.

The filter 11 is an example of the first filter and has a pass band including the transmit band of band n8 (communication band A) for 5G-NR. Band n8 for 5G-NR is an example of the first communication band.

The filter 12 has a pass band including the receive band of band n8 for 5G-NR.

The filter 22 is an example of the second filter and has a pass band including the receive band of band n5 (communication band B) for 5G-NR and the receive band of band n26 for 5G-NR.

The filter 23 has a pass band including the receive band of band n28 (communication band D) for 5G-NR or the receive band of band n12 for 5G-NR.

In the sixth modified example, band n8 and band n5 are a combination of bands that can be used for simultaneous communication. The frequency range of the transmit band of band n8 and that of the receive band of band n5 partially overlap each other. The transmit band of band n8 is an example of the first frequency band, while the receive band of band n5 is an example of the second frequency band. The transmit band of band n8 includes a sub-band X (first sub-band) that overlaps the receive band of band n5 and a sub-band Y (second sub-band) that does not overlap the receive band of band n5. The receive band of band n5 includes the sub-band X (first sub-band) that overlaps the transmit band of band n8 and a sub-band Z (third sub-band) that does not overlap the transmit band of band n8.

The pass band of the filter 11 can be switched between a first pass band including the sub-band X and the sub-band Y and a second pass band including the sub-band Y. The second pass band is narrower than the first pass band. One end of the filter 11 is connected to a first selection terminal of the switch 55.

The filter 22 has a pass band including the sub-band X and the sub-band Z. One end of the filter 22 is connected to a second selection terminal of the switch 55.

The matching circuit 75 is an example of the impedance matching circuit and is connected between a third selection terminal of the switch 55 and a ground.

The switch 55 is an example of the first switch. The switch 55 switches between the connection of a first antenna to the filters 11 and 12 and the disconnection of the first antenna from the filters 11 and 12, switches between the connection of the first antenna to the filter 22 and the disconnection of the first antenna from the filter 22, and switches between the connection of the first antenna to the filter 23 and the disconnection of the first antenna from the filter 23. The switch 55 also switches between the connection of the first antenna to the primary circuit 5C and the disconnection of the first antenna from the primary circuit 5C. The switch 55 switches between the connection of a second antenna to the filters 11 and 12 and the disconnection of the second antenna from the filters 11 and 12, switches between the connection of the second antenna to the filter 22 and the disconnection of the second antenna from the filter 22, and switches between the connection of the second antenna to the filter 23 and the disconnection of the second antenna from the filter 23. The switch 55 also switches between the connection of the second antenna to the primary circuit 5C and the disconnection of the second antenna from the primary circuit 5C. The switch 55 also switches between the connection of the second antenna to the matching circuit 75 and the disconnection of the second antenna from the matching circuit 75.

As illustrated in FIG. 9B, the primary circuit 5C includes filters 82, 83, 84, 91, and 92 and a switch 54.

The filter 82 has a pass band including the receive band of band n8 for 5G-NR.

The filter 83 has a pass band including the transmit band of band n28 for 5G-NR or the transmit band of band n12 for 5G-NR.

The filter 84 has a pass band including the receive band of band n28 for 5G-NR or the receive band of band n12 for 5G-NR.

The filter 91 has a pass band including the transmit band of band n5 for 5G-NR and the transmit band of band n26 for 5G-NR.

The filter 92 has a pass band including the receive band of band n5 for 5G-NR and the receive band of band n26 for 5G-NR.

The switch 54 switches between the connection of a third antenna to the filter 82 and the disconnection of the third antenna from the filter 82, switches between the connection of the third antenna to the filters 83 and 84 and the disconnection of the third antenna from the filters 83 and 84, and switches between the connection of the third antenna to the filters 91 and 92 and the disconnection of the third antenna from the filters 91 and 92. The switch 54 also switches between the connection of the third antenna to the radio-frequency circuit 1C and the disconnection of the third antenna from the radio-frequency circuit 1C. The switch 54 switches between the connection of a fourth antenna to the filter 82 and the disconnection of the fourth antenna from the filter 82, switches between the connection of the fourth antenna to the filters 83 and 84 and the disconnection of the fourth antenna from the filters 83 and 84, and switches between the connection of the fourth antenna to the filters 91 and 92 and the disconnection of the fourth antenna from the filters 91 and 92. The switch 54 also switches between the connection of the fourth antenna to the radio-frequency circuit 1C and the disconnection of the fourth antenna from the radio-frequency circuit 1C.

With the above-described configuration, the radio-frequency circuit 1C and the primary circuit 5C are able to execute: (1) a first mode in which a transmission signal of the sub-band Y of the communication band A and a reception signal of the sub-band Z of the communication band B are simultaneously transferred; (2) a second mode in which a transmission signal of the communication band A is transferred and a reception signal of the communication band B is not transferred; and (3) a third mode in which a reception signal of the communication band B is transferred and a transmission signal of the communication band A is not transferred.

With the above-described configuration, when the second mode is executed, the pass band of the filter 11 is set to the first pass band, so that a transmission signal of the communication band A can be transferred by using the entire range of the transmit band of the communication band A. When the second mode is executed, the filter 11 and the first antenna or the second antenna are connected to each other.

When the third mode is executed, a reception signal of the communication band B can be transferred with the use of the filter 22. When the third mode is executed, the filter 22 and the first antenna or the second antenna are connected to each other.

When the first mode is executed, the pass band of the filter 11 is set to the second pass band, and as shown in FIG. 9B, the filter 11 and the second antenna are connected to each other, and the filter 22 and the first antenna are connected to each other. The first antenna or the second antenna and the matching circuit 75 may be connected to each other. This can improve the isolation between a transmission signal of the communication band A to pass through the filter 11 and a reception signal of the communication band B to pass through the filter 22 and also reduce the degradation of the reception sensitivity of the communication band B.

When the first mode is executed, the filter 82 and the fourth antenna may be connected to each other, and the filters 91 and 92 and the third antenna may be connected to each other, as shown in FIG. 9B. This enables the primary circuit 5C to simultaneously transfer a reception signal of the communication band A and a reception signal of the communication band B.

### 2 Advantages and Others

As described above, a radio-frequency circuit 1 according to the embodiment includes filters 11 and 22. The filter 11 has a pass band including a first frequency band, which is one of the transmit band and the receive band of communication band A. The filter 22 has a pass band including a second frequency band, which is the other one of the transmit band and the receive band of communication band B. The communication band A and the communication band B are a combination of bands that can be used for simultaneous communication. The first frequency band includes a sub-band X that overlaps the second frequency band and a sub-band Y that does not overlap the second frequency band. The second frequency band includes the sub-band X and a sub-band Z that does not overlap the first frequency band. The pass band of the filter 11 is switchable between a first pass band including the sub-band X and the sub-band Y and a second pass band including the sub-band Y. The second pass band is narrower than the first pass band.

With this configuration, when a signal of the first frequency band is singly transferred, the pass band of the filter 11 is set to the first pass band, so that the signal can be transferred by using the entire range of the first frequency band. In contrast, when a signal of the sub-band Y and a signal of the sub-band Z are simultaneously transferred by allowing the signal of the sub-band Y to pass through the filter 11 and the signal of the sub-band Z to pass through the filter 22, even if the filters 11 and 22 are located close to each other, the isolation between the two signals can be improved by setting the pass band of the filter 11 to the second pass band. This can reduce the degradation of the reception sensitivity when the signal of the sub-band Y and the signal of the sub-band Z are simultaneously transferred. It is thus possible to provide a small-sized radio-frequency circuit 1 that can simultaneously transfer a transmission signal of the communication band A and a reception signal of the communication band B while reducing the degradation of isolation and reception sensitivity.

In one example, in the radio-frequency circuit 1, when, between a signal of the first frequency band and a signal of the second frequency band, the signal of the first frequency band is only transferred, the pass band of the filter 11 is set to the first pass band. When a signal of the first frequency band and a signal of the second frequency band are simultaneously transferred, the pass band of the filter 11 is set to the second pass band.

This makes it possible to improve the isolation between the signal of the first frequency band and the signal of the second frequency band and to reduce the degradation of the reception sensitivity.

In one example, in the radio-frequency circuit 1, the first frequency band is the transmit band of the communication band A, and the second frequency band is the receive band of the communication band B.

With this configuration, when a transmission signal of the communication band A is singly transferred, the pass band of the filter 11 is set to the first pass band, so that the transmission signal can be transferred by using the entire range of the transmit band of the communication band A. In contrast, when a transmission signal of the communication band A and a reception signal of the communication band B are simultaneously transferred by allowing the transmission signal to pass through the filter 11 and the reception signal to pass through the filter 22, even if the filters 11 and 22 are located close to each other, the isolation between the two signals can be improved by setting the pass band of the filter 11 to the second pass band. This can reduce the degradation of the reception sensitivity when the transmission signal of the communication band A and the reception signal of the communication band B are simultaneously transferred. It is thus possible to provide a small-sized radio-frequency circuit 1 that can simultaneously transfer a transmission signal of the communication band A and a reception signal of the communication band B while reducing the degradation of isolation and reception sensitivity.

In one example, in a radio-frequency circuit according to the first modified example, the first frequency band is the receive band of the communication band B, and the second frequency band is the transmit band of the communication band A. The pass band of the filter 22 is switchable between a first pass band including the sub-band X and the sub-band Z and a second pass band including the sub-band Z. The second pass band is narrower than the first pass band.

With this configuration, when a reception signal of the communication band B is singly transferred, the pass band of the filter 22 is set to the first pass band, so that the reception signal can be transferred by using the entire range of the receive band of the communication band B. In contrast, when a reception signal of the communication band B and a transmission signal of the communication band A are simultaneously transferred by allowing the reception signal to pass through the filter 22 and the transmission signal to pass through the filter 11, the isolation between the two signals can be improved by setting the pass band of the filter 22 to the second pass band. It is thus possible to reduce the degradation of the reception sensitivity of the communication band B when a reception signal of the communication band B and a transmission signal of the communication band A are simultaneously transferred.

In one example, in a radio-frequency circuit according to the third modified example, the sub-band Y overlaps at least one of the transmit band and the receive band of communication band C, and the sub-band X does not overlap at least one of the transmit band and the receive band of the communication band C. When a signal of at least one of the transmit band and the receive band of the communication band C that overlaps the sub-band Y is transferred, the pass band of the filter 11 is set to the second pass band.

With this configuration, when a signal of the communication band C is transferred, the pass band of the filter 11 is set to the second pass band, thereby making it possible to improve the quality of the signal of the communication band C to pass through the filter 11.

In one example, in the radio-frequency circuit according to the third modified example, the communication band C is band n106 for 5G-NR.

In one example, in a radio-frequency circuit according to the second modified example, the pass band of the filter 11 is switchable between a first pass band including the sub-band X and the sub-band Y and a second pass band including the sub-band Y. The second pass band is narrower than the first pass band. The pass band of the filter 22 is switchable between a third pass band including the sub-band X and the sub-band Z and a fourth pass band including the sub-band Z. The fourth pass band is narrower than the third pass band.

With this configuration, since the pass band of the filter 11 and that of the filter 22 are both variable, even if the filters 11 and 22 are located close to each other, the isolation between a signal of the communication band A and a signal of the communication band B can be secured. It is thus possible to reduce the degradation of the reception sensitivity when a signal of the sub-band Y and a signal of the sub-band Z are simultaneously transferred.

In one example, in the radio-frequency circuit according to the second modified example, when, between a signal of the first frequency band and a signal of the second frequency band, the signal of the first frequency band is only transferred, the pass band of the filter 11 is set to the first pass band. When, between a signal of the first frequency band and a signal of the second frequency band, the signal of the second frequency band is only transferred, the pass band of the filter 22 is set to the third pass band. When a signal of the first frequency band and a signal of the second frequency band are simultaneously transferred, the pass band of the filter 11 is set to the second pass band, and the pass band of the filter 22 is set to the fourth pass band.

This can improve the isolation between a signal of the first frequency band and a signal of the second frequency band and also reduce the degradation of the reception sensitivity.

In one example, the radio-frequency circuit 1 also includes a switch 50. The switch 50 includes a terminal 50a connected to an antenna, a terminal 50b connected to an antenna, a terminal 50c connected to the filter 11, and a terminal 50d connected to the filter 22.

With this configuration, it is possible to implement: single transfer of a signal of the first frequency band to pass through the filter 11; single transfer of a signal of the second frequency band to pass through the filter 22; and simultaneous transfer of a signal of the first frequency band to pass through the filter 11 and a signal of the second frequency band to pass through the filter 22.

In one example, in the radio-frequency circuit 1, when, between a signal of the first frequency band and a signal of the second frequency band, the signal of the first frequency band is only transferred, the terminal 50c is connected to the terminal 50a, and the terminal 50d is connected to neither of the terminal 50a nor the terminal 50b. When a signal of the first frequency band and a signal of the second frequency band are simultaneously transferred, the terminal 50c is connected to the terminal 50a, and the terminal 50d is connected to the terminal 50b.

With this configuration, it is possible to implement while securing the isolation between signals: single transfer of a signal of the first frequency band to pass through the filter 11; single transfer of a signal of the second frequency band to pass through the filter 22; and simultaneous transfer of a signal of the first frequency band to pass through the filter 11 and a signal of the second frequency band to pass through the filter 22.

In one example, a radio-frequency circuit 1A according to the fourth modified example also includes a filter 13, a matching circuit 75, and a switch 51. The filter 13 is connected to the terminal 51c and has a pass band including a third frequency band which is one of the transmit band and the receive band of communication band D. The switch 51 switches between the connection of the terminal 51c to the matching circuit 75 and the disconnection of the terminal 51c from the matching circuit 75. The third frequency band overlaps neither of the first frequency band nor the second frequency band.

With the above-described configuration, the radio-frequency circuit 1A is able to execute: (1) a fifth mode in which a signal of the communication band A, a signal of the communication band B, and a signal of the communication band D are simultaneously transferred; (2) a sixth mode in which a signal of the communication band A and a signal of the communication band D are transferred and a signal of the communication band B is not transferred; and (3) a third mode in which a signal of the communication band B is transferred and a signal of the communication band A is not transferred.

With the above-described configuration, when the mode is switched between the fifth, sixth, and third modes, the switch 51 switches between the connection and the disconnection of the matching circuit 75, thereby making it possible to improve the attenuation characteristics of the filter 11 for the communication band D.

In one example, in the radio-frequency circuit 1A, when, between a signal of the first frequency band and a signal of the second frequency band, the signal of the first frequency band is only transferred, the terminal 51c is connected to the terminal 51a, the terminal 51d is connected to neither of the terminal 51a nor the terminal 51b, and the matching circuit 75 is connected to neither of the terminal 51c nor the terminal 51e. When a signal of the first frequency band and a signal of the second frequency band are simultaneously transferred, the terminal 51c is connected to the terminal 51a, the terminal 51d is connected to the terminal 51b, and the matching circuit 75 is connected to the terminal 51c.

When the sixth mode is switched to the fifth mode, the pass band of the filter 11 is changed from the first pass band to the second pass band. This changes the attenuation characteristics of the filter 11 for the communication band D. To address this issue, when the sixth mode is switched to the fifth mode, as a result of connecting the matching circuit 75 to the filter 11, the attenuation characteristics of the filter 11 can be adjusted in response to the switching of the pass band of the filter 11, thereby improving the attenuation characteristics of the filter 11 for the communication band D. When a signal of the communication band A and a signal of the communication band B whose frequency bands partially overlap each other are simultaneously transferred, the degradation of isolation and reception sensitivity can be regulated. Additionally, the communication band D can be transferred simultaneously with the communication band A and the communication band B with a small loss.

In one example, in the radio-frequency circuit 1A, the communication band D is one of band 28 for 4G-LTE, band 12 for 4G-LTE, band n28 for 5G-NR, and band n12 for 5G-NR.

In one example, the radio-frequency circuit 1 includes a first switch, which is an SPDT switch, instead of the switch 50; the radio-frequency circuit 1A includes a first switch, which is an SPDT switch, instead of the switch 51; and a radio-frequency circuit 1B according to the fifth modified example includes a first switch, which is an SPDT switch, instead of a switch 52. The SPDT first switch includes an antenna connection terminal, a first terminal connected to the filter 11, and a second terminal connected to the filter 22.

With this configuration, it is possible to implement: single transfer of a signal of the first frequency band to pass through the filter 11; single transfer of a signal of the second frequency band to pass through the filter 22; and simultaneous transfer of a signal of the first frequency band to pass through the filter 11 and a signal of the second frequency band to pass through the filter 22.

In one example, in the radio-frequency circuits 1, 1A and 1B, when, between a signal of the first frequency band and a signal of the second frequency band, the signal of the first frequency band is only transferred, the first terminal is connected to the antenna connection terminal, and the second terminal is not connected to the antenna connection terminal. When a signal of the first frequency band and a signal of the second frequency band are simultaneously transferred, the first terminal is connected to the antenna connection terminal, and the second terminal is connected to the antenna connection terminal.

With this configuration, it is possible to implement while securing the isolation between signals: single transfer of a signal of the first frequency band to pass through the filter 11; single transfer of a signal of the second frequency band to pass through the filter 22; and simultaneous transfer of a signal of the first frequency band to pass through the filter 11 and a signal of the second frequency band to pass through the filter 22.

In one example, in the radio-frequency circuits 1, 1A and 1B, the communication band A is one of band 8 for 4G-LTE and band n8 for 5G-NR, and the communication band B is one of band 5 for 4G-LTE and band n5 for 5G-NR.

In one example, a communication device 4 includes an RFIC 3 that processes a radio-frequency signal and the radio-frequency circuit 1 that transfers a radio-frequency signal between the RFIC 3 and each of the antennas 2a and 2b.

With this configuration, the communication device 4 can implement the advantages of the radio-frequency circuit 1.

### Other Embodiments

A radio-frequency circuit and a communication device according to an embodiment of the present disclosure has been discussed above through illustration of the embodiment and modified examples, but they are not restricted to the above-described embodiment and modified examples. Other embodiments implemented by combining certain elements in the above-described embodiment and modified examples and other modified examples obtained by making various modifications to the above-described embodiment and modified examples by those skilled in the art without departing from the scope and spirit of the invention are also encompassed in the invention. Various types of equipment integrating any of the above-described radio-frequency circuits and communication devices are also encompassed in the invention.

In one example, in the circuit configurations of the radio-frequency circuits and communication devices according to the above-described embodiment and modified examples, another circuit element and another wiring may be inserted onto a path connecting circuit elements and/or onto a path connecting signal paths illustrated in the drawings.

In the above-described embodiment and modified examples, cellular bands for 5G-NR or LTE are used. In addition to or instead of 5G-NR or LTE, however, a communication band for another RAT may be used. For example, a communication band for a WLAN may be used.

The features of the radio-frequency circuits and communication devices discussed through illustration of the above-described embodiment and modified examples are as follows.
<1>

A radio-frequency circuit comprising:
a first filter having a pass band including a first frequency band, the first frequency band being one of a transmit band and a receive band of a first communication band; and
a second filter having a pass band including a second frequency band, the second frequency band being the other one of the transmit band and the receive band of a second communication band, wherein
the first communication band and the second communication band are a combination of bands that are usable for simultaneous communication,
the first frequency band includes a first sub-band that overlaps the second frequency band and a second sub-band that does not overlap the second frequency band,
the second frequency band includes the first sub-band and a third sub-band that does not overlap the first communication band, and
the pass band of the first filter is switchable between a first pass band including the first sub-band and the second sub-band and a second pass band including the second sub-band, the second pass band being narrower than the first pass band.
<2>

The radio-frequency circuit according to <1>, wherein:
when, between a signal of the first frequency band and a signal of the second frequency band, the signal of the first frequency band is only transferred, the pass band of the first filter is switched to the first pass band; and
when a signal of the first frequency band and a signal of the second frequency band are simultaneously transferred, the pass band of the first filter is switched to the second pass band.
<3>

The radio-frequency circuit according to <1> or <2>, wherein:
the first frequency band is the transmit band of the first communication band; and
the second frequency band is the receive band of the second communication band.
<4>

The radio-frequency circuit according to <1> or <2>, wherein:
the first frequency band is the receive band of the first communication band; and
the second frequency band is the transmit band of the second communication band.
<5>

The radio-frequency circuit according to one of <1> to <4>, wherein:
the second sub-band overlaps at least one of the transmit band and the receive band of a third communication band;
the first sub-band does not overlap the at least one of the transmit band and the receive band of the third communication band; and
when a signal of the at least one of the transmit band and the receive band of the third communication band is transferred, the pass band of the first filter is switched to the second pass band.
<6>

The radio-frequency circuit according to <5>, wherein the third communication band is band n106 for 5G-NR.
<7>

The radio-frequency circuit according to one of <1> to <6>, wherein the pass band of the second filter is switchable between a third pass band including the first sub-band and the third sub-band and a fourth pass band including the third sub-band, the fourth pass band being narrower than the third pass band.
<8>

The radio-frequency circuit according to <7>, wherein:
when, between a signal of the first frequency band and a signal of the second frequency band, the signal of the first frequency band is only transferred, the pass band of the first filter is switched to the first pass band;
when, between a signal of the first frequency band and a signal of the second frequency band, the signal of the second frequency band is only transferred, the pass band of the second filter is switched to the third pass band; and
when a signal of the first frequency band and a signal of the second frequency band are simultaneously transferred, the pass band of the first filter is switched to the second pass band, and the pass band of the second filter is switched to the fourth pass band.
<9>

The radio-frequency circuit according to one of <1> to <8>, further comprising:
a first switch including first and second antenna connection terminals and first and second terminals, the first terminal being connected to the first filter, the second terminal being connected to the second filter.
<10>

The radio-frequency circuit according to <9>, wherein:
when, between a signal of the first frequency band and a signal of the second frequency band, the signal of the first frequency band is only transferred, the first terminal is connected to one of the first antenna connection terminal and the second antenna connection terminal, and the second terminal is connected to neither of the first antenna connection terminal nor the second antenna connection terminal; and
when a signal of the first frequency band and a signal of the second frequency band are simultaneously transferred, the first terminal is connected to one of the first antenna connection terminal and the second antenna connection terminal, and the second terminal is connected to one of the first antenna connection terminal and the second antenna connection terminal.
<11>

The radio-frequency circuit according to <9> or <10>, further comprising:
a third filter that is connected to the first terminal and that has a pass band including a third frequency band, the third frequency band being one of the transmit band and the receive band of a fourth communication band;
an impedance matching circuit; and
a second switch that switches between connection of the first terminal to the impedance matching circuit and disconnection of the first terminal from the impedance matching circuit,
wherein the third frequency band overlaps neither of the first frequency band nor the second frequency band.
<12>

The radio-frequency circuit according to <11>, wherein:
when, between a signal of the first frequency band and a signal of the second frequency band, the signal of the first frequency band is only transferred, the first terminal is connected to one of the first antenna connection terminal and the second antenna connection terminal, the second terminal is connected to neither of the first antenna connection terminal nor the second antenna connection terminal, and the impedance matching circuit is not connected to the first terminal; and
when a signal of the first frequency band and a signal of the second frequency band are simultaneously transferred, the first terminal is connected to one of the first antenna connection terminal and the second antenna connection terminal, the second terminal is connected to one of the first antenna connection terminal and the second antenna connection terminal, and the impedance matching circuit is connected to the first terminal.
<13>

The radio-frequency circuit according to <11> or <12>, wherein the fourth communication band is one of band 28 for 4G-LTE, band 12 for 4G-LTE, band n28 for 5G-NR, and band n12 for 5G-NR.
<14>

The radio-frequency circuit according to one of <1> to <8>, further comprising:
a first switch including an antenna connection terminal and first and second terminals, the first terminal being connected to the first filter, the second terminal being connected to the second filter.
<15>

The radio-frequency circuit according to <14>, wherein:
when, between a signal of the first frequency band and a signal of the second frequency band, the signal of the first frequency band is only transferred, the first terminal is connected to the antenna connection terminal, and the second terminal is not connected to the antenna connection terminal; and
when a signal of the first frequency band and a signal of the second frequency band are simultaneously transferred, the first terminal is connected to the antenna connection terminal, and the second terminal is connected to the antenna connection terminal.
<16>

The radio-frequency circuit according to <14> or <15>, further comprising:
a third filter that is connected to the first terminal and that has a pass band including a third frequency band, the third frequency band being one of the transmit band and the receive band of a fourth communication band;
an impedance matching circuit; and
a second switch that switches between connection of the first terminal to the impedance matching circuit and disconnection of the first terminal from the impedance matching circuit,
wherein the third frequency band overlaps neither of the first frequency band nor the second frequency band.
<17>

The radio-frequency circuit according to <16>, wherein:
when, between a signal of the first frequency band and a signal of the second frequency band, the signal of the first frequency band is only transferred, the first terminal is connected to the antenna connection terminal, the second terminal is not connected to the antenna connection terminal, and the impedance matching circuit is not connected to the first terminal; and
when a signal of the first frequency band and a signal of the second frequency band are simultaneously transferred, the first terminal is connected to the antenna connection terminal, the second terminal is connected to the antenna connection terminal, and the impedance matching circuit is connected to the first terminal.
<18>

The radio-frequency circuit according to <16> or <17>, wherein the fourth communication band is one of band 28 for 4G-LTE, band 12 for 4G-LTE, band n28 for 5G-NR, and band n12 for 5G-NR.
<19>

The radio-frequency circuit according to one of <1> to <18>, wherein:
the first communication band is one of band 8 for 4G-LTE and band n8 for 5G-NR; and
the second communication band is one of band 5 for 4G-LTE and band n5 for 5G-NR.
<20>

A communication device comprising:
a signal processing circuit that processes a radio-frequency signal; and
the radio-frequency circuit according to one of <1> to <19> that transfers the radio-frequency signal between the signal processing circuit and an antenna.

The present invention can be widely used for communication equipment, such as a mobile phone, as a radio-frequency circuit disposed in a front-end section.

What is claimed is:

1. A radio-frequency circuit comprising:
a first filter having a pass band including a first frequency band, the first frequency band being one of a transmit band and a receive band of a first communication band; and
a second filter having a pass band including a second frequency band, the second frequency band being the other one of the transmit band and the receive band of a second communication band, wherein
the first communication band and the second communication band are a combination of bands that are usable for simultaneous communication,
the first frequency band includes a first sub-band that overlaps the second frequency band and a second sub-band that does not overlap the second frequency band,
the second frequency band includes the first sub-band and a third sub-band that does not overlap the first communication band, and
the pass band of the first filter is switchable between a first pass band including the first sub-band and the second sub-band and a second pass band including the second sub-band, the second pass band being narrower than the first pass band.

2. The radio-frequency circuit according to claim 1, wherein:
when, between a signal of the first frequency band and a signal of the second frequency band, the signal of the first frequency band is only transferred, the pass band of the first filter is switched to the first pass band; and
when a signal of the first frequency band and a signal of the second frequency band are simultaneously transferred, the pass band of the first filter is switched to the second pass band.

3. The radio-frequency circuit according to claim 1, wherein:
the first frequency band is the transmit band of the first communication band; and
the second frequency band is the receive band of the second communication band.

4. The radio-frequency circuit according to claim 1, wherein:
the first frequency band is the receive band of the first communication band; and
the second frequency band is the transmit band of the second communication band.

5. The radio-frequency circuit according to claim 1, wherein:
the second sub-band overlaps at least one of the transmit band and the receive band of a third communication band;
the first sub-band does not overlap the at least one of the transmit band and the receive band of the third communication band; and
when a signal of the at least one of the transmit band and the receive band of the third communication band is transferred, the pass band of the first filter is switched to the second pass band.

6. The radio-frequency circuit according to claim 5, wherein the third communication band is band n106 for 5G-NR.

7. The radio-frequency circuit according to claim 1, wherein the pass band of the second filter is switchable between a third pass band including the first sub-band and the third sub-band and a fourth pass band including the third sub-band, the fourth pass band being narrower than the third pass band.

8. The radio-frequency circuit according to claim 7, wherein:
when, between a signal of the first frequency band and a signal of the second frequency band, the signal of the first frequency band is only transferred, the pass band of the first filter is switched to the first pass band;
when, between a signal of the first frequency band and a signal of the second frequency band, the signal of the second frequency band is only transferred, the pass band of the second filter is switched to the third pass band; and
when a signal of the first frequency band and a signal of the second frequency band are simultaneously transferred, the pass band of the first filter is switched to the second pass band, and the pass band of the second filter is switched to the fourth pass band.

9. The radio-frequency circuit according to claim 1, further comprising:
a first switch including first and second antenna connection terminals and first and second terminals, the first terminal being connected to the first filter, the second terminal being connected to the second filter.

10. The radio-frequency circuit according to claim 9, wherein:
when, between a signal of the first frequency band and a signal of the second frequency band, the signal of the first frequency band is only transferred, the first terminal is connected to one of the first antenna connection terminal and the second antenna connection terminal, and the second terminal is connected to neither of the first antenna connection terminal nor the second antenna connection terminal; and
when a signal of the first frequency band and a signal of the second frequency band are simultaneously transferred, the first terminal is connected to one of the first antenna connection terminal and the second antenna connection terminal, and the second terminal is connected to one of the first antenna connection terminal and the second antenna connection terminal.

11. The radio-frequency circuit according to claim 9, further comprising:
a third filter that is connected to the first terminal and that has a pass band including a third frequency band, the third frequency band being one of the transmit band and the receive band of a fourth communication band;
an impedance matching circuit; and
a second switch that switches between connection of the first terminal to the impedance matching circuit and disconnection of the first terminal from the impedance matching circuit,
wherein the third frequency band overlaps neither of the first frequency band nor the second frequency band.

12. The radio-frequency circuit according to claim 11, wherein:
when, between a signal of the first frequency band and a signal of the second frequency band, the signal of the first frequency band is only transferred, the first terminal is connected to one of the first antenna connection terminal and the second antenna connection terminal, the second terminal is connected to neither of the first antenna connection terminal nor the second antenna connection terminal, and the impedance matching circuit is not connected to the first terminal; and
when a signal of the first frequency band and a signal of the second frequency band are simultaneously transferred, the first terminal is connected to one of the first antenna connection terminal and the second antenna connection terminal, the second terminal is connected to one of the first antenna connection terminal and the second antenna connection terminal, and the impedance matching circuit is connected to the first terminal.

13. The radio-frequency circuit according to claim 11, wherein the fourth communication band is one of band 28 for 4G-LTE, band 12 for 4G-LTE, band n28 for 5G-NR, and band n12 for 5G-NR.

14. The radio-frequency circuit according to claim 1, further comprising:
a first switch including an antenna connection terminal and first and second terminals, the first terminal being connected to the first filter, the second terminal being connected to the second filter.

15. The radio-frequency circuit according to claim 14, wherein:
when, between a signal of the first frequency band and a signal of the second frequency band, the signal of the first frequency band is only transferred, the first terminal is connected to the antenna connection terminal, and the second terminal is not connected to the antenna connection terminal; and
when a signal of the first frequency band and a signal of the second frequency band are simultaneously transferred, the first terminal is connected to the antenna connection terminal, and the second terminal is connected to the antenna connection terminal.

16. The radio-frequency circuit according to claim 14, further comprising:
a third filter that is connected to the first terminal and that has a pass band including a third frequency band, the third frequency band being one of the transmit band and the receive band of a fourth communication band;
an impedance matching circuit; and
a second switch that switches between connection of the first terminal to the impedance matching circuit and disconnection of the first terminal from the impedance matching circuit,
wherein the third frequency band overlaps neither of the first frequency band nor the second frequency band.

17. The radio-frequency circuit according to claim 16, wherein:
when, between a signal of the first frequency band and a signal of the second frequency band, the signal of the first frequency band is only transferred, the first terminal is connected to the antenna connection terminal, the second terminal is not connected to the antenna connection terminal, and the impedance matching circuit is not connected to the first terminal; and
when a signal of the first frequency band and a signal of the second frequency band are simultaneously transferred, the first terminal is connected to the antenna connection terminal, the second terminal is connected to the antenna connection terminal, and the impedance matching circuit is connected to the first terminal.

18. The radio-frequency circuit according to claim 16, wherein the fourth communication band is one of band 28 for 4G-LTE, band 12 for 4G-LTE, band n28 for 5G-NR, and band n12 for 5G-NR.

19. The radio-frequency circuit according to claim 1, wherein:
the first communication band is one of band 8 for 4G-LTE and band n8 for 5G-NR; and
the second communication band is one of band 5 for 4G-LTE and band n5 for 5G-NR.

20. A communication device comprising:
a signal processing circuit that processes a radio-frequency signal; and
the radio-frequency circuit according to claim 1 that transfers the radio-frequency signal between the signal processing circuit and an antenna.
